(19) United States
(12) Patent Application Publication
(10) Pub. No.: US 2010/0330420 A1
(43) Pub. Date: Dec. 30, 2010

(54) METHOD FOR MANUFACTURING ELECTROCHEMICAL ELEMENT ELECTRODE

(76) Inventors: Yuko Ogawa, Osaka (JP); Kazuyoshi Honda, Osaka (JP)

Correspondence Address: MCDERMOTT WILL & EMERY LLP, 600 13TH STREET, NW, WASHINGTON, DC, 20005-3096, US

(21) Appl. No.: 12/865,076

(22) PCT Filed: Dec. 16, 2008
(86) PCT No.: PCT/JP2008/003792

§ 371 Date: Jul. 28, 2010

(30) Foreign Application Priority Data
Jan. 29, 2008 (JP) 2008-017757
May 28, 2008 (JP) 2008-139780

(51) Int. Cl. H01M 4/13; H01M 4/04; B05D 5/12

(52) U.S. Cl. 429/209; 427/78

(57) ABSTRACT

Includes the steps of preparing a sheet-like current collector 4 having a plurality of bumps 4A on a surface thereof, the plurality of bumps having a height of 3 μm or greater and 10 μm or less; and forming an active material body having a stacked structure on each of the bumps 4A of the current collector 4. The step of forming the active material body includes a first layer vapor deposition step of causing a vaporized vapor deposition material to be incident on the surface of the current collector 4 in a direction inclined with respect to the normal H to the current collector 4 to form a first layer 101a of the active material body on each bump 4A, the first layer 101a being located closest to the current collector; and a second layer vapor deposition step of causing the vaporized vapor deposition material to be incident on the surface of the current collector 4 in a direction inclined, with respect to the normal H to the current collector 4, opposite to the incidence direction of the vapor deposition material in the first layer vapor deposition step to form a second layer 102a on at least a part of the first layer 101a. In the first layer vapor deposition step, vapor deposition is performed while moving the current collector 4 in a direction in which the incidence angle ω of the vapor deposition material with respect to the normal H to the current collector 4 is decreased.

### TECHNICAL FIELD

The present invention relates to an electrode for an electrochemical device including a current collector and an active material carried by the current collector, and a method for producing the same.

### BACKGROUND ART

Recently, along with the development of portable devices such as personal computers, mobile phones and the like, there is increasing demand for cells as power supplies of these devices. Cells for such uses are desired to have a high energy density and a superb cycle characteristic.

As a response to such a desire, nonaqueous electrolytic lithium secondary cells are now a target of attention, which use any of various types of nonaqueous electrolysis such as, for example, an organic electrolytic solution or a gel polymeric electrolysis obtained by defluidizing an organic electrolytic solution by use of a polymer or a gelating agent as an electrolysis, and use lithium ions as a charge-migrating medium. Usable as a positive electrode material of such a nonaqueous electrolytic lithium secondary cell are materials which are capable of reversibly occluding and releasing lithium ions with any of various types of electrolysis and exhibiting a high reversible potential, for example, LiCoO₂, LiNiO₂ and LiMn₂O₄. Usable as a negative electrode material are materials exhibiting a low reversible potential, for example, various carbon materials such as graphite, carbon and the like.

As the functions of the portable devices have been improving, the power supplies are now desired to have a still higher energy density. In such circumstances, it has been proposed to use, as the negative electrode material, a large capacity negative electrode material which is capable of forming an inter-metal compound with Li and providing a very large capacity by occluding and releasing lithium, in place of a carbon material such as graphite, carbon or the like. Usable as such as large capacity negative electrode material are, for example, Si (silicon), Sn (tin) and alloys containing Si or Sn as a main component. Si has a theoretic discharge capacity of about 4199 mAh/g, which is about 11 times the theoretic discharge capacity of graphite.

Such a large capacity negative electrode material (hereinafter, also referred to simply as the “negative electrode active material”) significantly expands and contracts when occluding and releasing lithium ions for charge and discharge. Therefore, where a thin film containing a negative electrode active material (hereinafter, referred to as the “active material layer”) is deposited on a current collector to form a negative electrode, the active material layer expands and contracts by the lithium ions being occluded and released, whereas the current collector does not expand or contract almost at all. As a result, the negative electrode including the current collector is distorted because of generation of a large stress. This may undesirably wrinkle or rupture the current collector or delaminate the active material layer from the current collector. When the negative electrode is distorted or wrinkled, a gap is made between the negative electrode and the separator to cause a non-uniform charge/discharge reaction, which may undesirably cause a local decline of cell characteristics. In addition, when the active material layer is delaminated from the current collector, the electron conductivity of the negative electrode may be decreased and as a result a sufficiently high charge/discharge cycle characteristic may possibly not be provided.

In order to solve these problems caused by the expansion and contraction of the negative electrode active material, it has been proposed to locate a plurality of pillar-like bodies containing a negative electrode active material (hereinafter, referred to as the “active material body”) on the current collector and thus provide a space between each two adjacent active material bodies, so as to alleviate the expansion stress of the negative electrode active material.

For example, Patent Document No. 1 proposes the following. On a surface of the current collector, a negative electrode active material is vapor-deposited in a direction inclined with respect to the normal direction to the current collector (oblique vapor deposition). Thus, using the shadowing effect described later, a plurality of active material bodies inclined with respect to the normal direction to the current collector are grown at certain intervals.

Patent Document No. 2 proposes the following. A regular ruggedness pattern is formed in a surface of the current collector. On each of the bumps, an active material body is grown by oblique vapor deposition. With this structure, the size of the space between the active material bodies can be controlled by the size or the pitch of the ruggedness pattern. Therefore, the expansion stress of the active material bodies can be effectively decreased. Patent Document No. 2 also discloses a method and an apparatus for moving a sheet-like current collector while continuously forming active material bodies on a surface thereof by oblique vapor deposition.

In order to alleviate the expansion stress of the active material applied on the current collector more effectively, it has been proposed to perform oblique vapor deposition a plurality of times while switching the vapor deposition direction, so as to grow active material bodies in a zigzag manner (for example, Patent Documents Nos. 2 through 4). The zigzag active material bodies are formed, for example, as follows.

First, on a current collector having projections (bumps) on a surface thereof, vapor deposition is performed in a first direction inclined with respect to the normal direction to the current collector to form a first layer on each of the bumps. Next, vapor deposition is performed in a second direction inclined, with respect to the normal direction to the current collector, oppositely to the first direction to form a second layer on the first layer. Then, vapor deposition is performed in the first direction to form a third layer. Vapor deposition is repeated while switching the vapor deposition direction until an arbitrary number of layers are formed. Thus, the active material bodies are obtained.

For forming such active material bodies, a vapor deposition apparatus as described below is used. In a vacuum chamber of the vapor deposition apparatus, a vaporization source and a fixing table for fixing the current collector are located. The fixing table is located such that a surface thereof is inclined with respect to a plane parallel to a vaporization surface of the vaporization source (top surface of the vapor deposition material). Owing to this, the vapor deposition material can be incident on the surface of the current collector in a direction inclined, at an arbitrary angle, with respect to the normal direction to the current collector. By switching the inclination direction of the fixing table, the direction of incidence of the vapor deposition material (vapor deposition direction) can be switched. Accordingly, by repeating vapor deposition a plurality of times while the inclination direction of the fixing table is switched, the zigzag active material bodies as described above can be provided.

Patent Document No. 4 proposes, in order to grow the active material bodies in a zigzag manner, switching the direction of incidence of the vapor deposition material by changing the position of the vaporization source or by using a plurality of vaporization sources alternately.

Patent Document No. 1: Japanese Laid-Open Patent Publication No. 2005-196970

Patent Document No. 2: International Publication WO2007/094311 pamphlet

Patent Document No. 3: International. Publication WO2007/086411 pamphlet

Patent Document No. 4: International Publication WO2007/052803 pamphlet

### DISCLOSURE OF THE INVENTION

### Problems to be Solved by the Invention

According to the structures of Patent Documents Nos. 1 through 4, the active material bodies can be located on bumps formed on the surface of the current collector. Therefore, a space in which the active material bodies are allowed to expand can be obtained more certainly.

However, as a result of the study performed by the present inventors, the following was found. For example, when the active material bodies are continuously formed using the apparatus disclosed in Patent Document No. 2, there may be cases where the vapor deposition particles enter the space between the active material bodies and so the active material is grown also on the dents of the current collector (areas between each two adjacent bumps, i.e., grooves) when the vapor deposition particles for oblique vapor deposition are incident at a certain angle or the bumps have a certain size. The reason for this will be described later. When the amount of the active material grown on the dents increases and a thick active material film is formed, the current collector may undesirably be wrinkled or ruptured easily by the expansion stress of the active material film.

When the active material bodies are grown on the bumps, there are problems that the size of contact area between the active material bodies and the current collector decreases and so the adhering strength between the current collector and the active material bodies decreases. Therefore, although the electrode is suppressed from being wrinkled or ruptured by the expansion stress of the active material at the time of charge/discharge, the active material bodies may undesirably be delaminated from the current collector and so the charge/discharge cycle characteristic may be deteriorated.

In addition, when the active material bodies are formed by any of the methods described in Patent Documents Nos. 1 through 4, there may be cases where the width of the active material bodies increases and so it becomes difficult to certainly obtain a sufficiently large space, between each two adjacent active material bodies, in which the active material bodies are allowed to expand. Herein, the “width of the active material bodies” means the maximum possible width of each active material body in a plane parallel to the surface of the current collector. The “plane parallel to the surface of the current collector” means a plane parallel to a virtual plane obtained by averaging the bumps and dents on the surface of the current collector.

For forming the above-described zigzag active material bodies, any of the vapor deposition apparatuses disclosed in Patent Documents Nos. 2 through 4 is usable. In these vapor deposition apparatuses, vapor deposition is performed on a current collector which has been cut into a size corresponding to the size of the fixing table. Therefore, the productivity of these apparatuses is low and it is difficult to use the apparatuses for mass production processes.

The present invention made in light of the above-described situation has an object of producing an electrode, for an electrochemical device, which has a large capacity and a superb charge/discharge cycle characteristic by a highly productive method.

### Means for Solving the Problems

A method for producing an electrode for an electrochemical device according to the present invention includes the steps of preparing a sheet-like current collector having a plurality of bumps on a surface thereof; and forming an active material body having a stacked structure on each of the bumps of the current collector. The step of forming the active material body includes a first layer vapor deposition step of causing a vaporized vapor deposition material to be incident on the surface of the current collector in a direction inclined with respect to the normal to the current collector to form a first layer of the active material body on each bump, the first layer being located closest to the current collector; and a second layer vapor deposition step of causing the vaporized vapor deposition material to be incident on the surface of the current collector in a direction inclined, with respect to the normal to the current collector, opposite to the incidence direction of the vapor deposition material in the first layer vapor deposition step to form a second layer on at least a part of the first layer. In the first layer vapor deposition step, vapor deposition is performed while moving the current collector in a direction in which the incidence angle of the vapor deposition material with respect to the normal to the current collector is decreased.

In a preferable embodiment, in the second layer vapor deposition step, vapor deposition is performed while moving the current collector in a direction in which the incidence angle of the vapor deposition material with respect to the normal to the current collector is increased.

According to the present invention, each active material body is formed on a bump of the current collector. Therefore, a space for alleviating the expansion stress of the active material body can be formed more certainly between the active material bodies, and so the electrode can be suppressed from being deformed or wrinkled due to the expansion stress of the active material body.

Specifically, in the first layer vapor deposition step, while the amount of the active material deposited on the dents of the current collector (the parts in which the bumps are not formed) is suppressed to be low, the active material can be deposited selectively on a side surface and a top surface of each bump of the current collector. Next, in the second layer vapor deposition step, vapor deposition is performed in a direction inclined, with respect to the normal to the current collector, oppositely to the incidence direction of the vapor deposition material in the first layer vapor deposition step. Therefore, the active material can be deposited on a side surface of the bump which is not covered with the first layer. In this manner, the first and second layers can be formed so as to cover the entire surface of the bump, which can increase the adhering strength between the active material bodies including the first and second layers and the bump of the current collector. Therefore, the deterioration of the charge/discharge characteristic which would otherwise be caused by the delamination of the active material can be suppressed. In addition, the amount of the active material deposited on the dents of the current collector can be decreased, and so the expansion stress applied on the current collector can be alleviated.

In the second layer vapor deposition step, it is preferable that vapor deposition is performed while the current collector is moved in a direction in which the incidence angle of the vapor deposition material with respect to the normal to the current collector is increased. Owing to this, the active material can be deposited in a sufficient thickness on the side surface of the bumps while the deposition of the active material on the dents of the current collector is suppressed. Therefore, the adherence between the active material bodies and the side surface of the bumps, as well as the top surface of the bumps, can be effectively improved. In addition, the first layer and the second layer can be continuously formed in the chamber, which improves the productivity.

Accordingly, an electrode, for an electrochemical device, which provides a large capacity and is highly reliable can be produced by a simple and highly productive process.

### EFFECTS OF THE INVENTION

According to the present invention, a space for alleviating the expansion stress of the active material layer is certainly provided between active material bodies, while the contact area size is increased, and so the adherence can be improved, between the active material bodies and the surface of the bumps of the current collector. In addition, the amount of the active material deposited on the dents of the current collector can be decreased.

Accordingly, the electrode can be suppressed from being distorted, wrinkled or ruptured due to the repetition of charge/discharge, and also the active material bodies can be suppressed from being delaminated from the current collector due to the repetition of charge/discharge. Thus, an electrode for an electrochemical device having highly reliable charge/discharge cycle characteristic and other characteristics can be provided using an active material largely expandable and contractable.

Also according to the present invention, an electrode as described above can be produced by a simple and highly productive method.

### BRIEF DESCRIPTION OF THE DRAWINGS

FIGS. 1(a) through 1(e) are cross-sectional views showing steps of a method for producing an electrode in Embodiment 1 according to the present invention.

FIGS. 2(a) through 2(d) are cross-sectional views showing steps of the method for producing the electrode in Embodiment 1 according to the present invention.

FIGS. 3(a) through 3(d) are cross-sectional views showing steps of the method for producing the electrode in Embodiment 1 according to the present invention.

FIGS. 4(a) through 4(c) are cross-sectional views showing steps of the method for producing the electrode in Embodiment 1 according to the present invention.

FIG. 5 is a cross-sectional view showing a step of the method for producing the electrode in Embodiment 1 according to the present invention.

FIG. 6(a) is a schematic cross-sectional view of a vapor deposition apparatus usable for the method in Embodiment 1 according to the present invention; and FIG. 6(b) is a schematic enlarged cross-sectional view illustrating an incidence angle of a vapor deposition material in a vapor deposition zone in the vapor deposition apparatus shown in FIG. 6(a).

FIG. 7(a) is a schematic cross-sectional view of another vapor deposition apparatus usable for the method in Embodiment 1 according to the present invention; and FIG. 7(b) is a schematic enlarged cross-sectional view illustrating the incidence angle of the vapor deposition material in a vapor deposition zone in the vapor deposition apparatus shown in FIG. 7(a).

FIGS. 8(a) and 8(b) are cross-sectional views showing another structure of an active material body formed by the method for producing the electrode in Embodiment 1 according to the present invention.

FIG. 9 is a schematic cross-sectional view showing an example of a lithium secondary cell using the electrode according to the present invention.

FIGS. 10(a) and 10(b) are respectively a cross-sectional view and a top view of a current collector used in an example and a comparative example.

FIG. 11(a) is a cross-sectional view of active material bodies in Example 1, and 11(b) is a top view of an active material layer in Example 1.

FIG. 12(a) is a schematic cross-sectional view of a vapor deposition apparatus usable for the method in Reference Embodiment according to the present invention; and FIG. 12(b) is a schematic enlarged cross-sectional view illustrating the incidence angle of the vapor deposition material in a vapor deposition zone in the vapor deposition apparatus shown in FIG. 12(a).

FIG. 13(a) is a cross-sectional view of active material bodies in Comparative Example 1, and 13(b) is a top view of an active material layer in Comparative Example 1.

FIGS. 14(a) through 14(c) are cross-sectional views showing steps of a method for producing an electrode in Reference Embodiment according to the present invention.

FIGS. 15(a) and 15(b) are cross-sectional views showing steps of the method for producing the electrode in Reference Embodiment according to the present invention.

FIG. 16 is a schematic enlarged partial cross-sectional view of an electrode in Reference Embodiment according to the present invention.

FIG. 17 is a schematic cross-sectional view of another vapor deposition apparatus usable for the method in Reference Embodiment according to the present invention.

FIG. 18 is a schematic cross-sectional view of still another vapor deposition apparatus usable for the method in Reference Embodiment according to the present invention.

FIG. 19 shows a cross-section of an active material body in Reference Example 2.

FIG. 20 shows a cross-section of an active material body in Comparative Example 2.

FIGS. 21(a) through 21(c) are schematic cross-sectional views showing steps of a first layer vapor deposition step in an embodiment according to the present invention.

### DESCRIPTION OF THE REFERENCE NUMERALS

1 Chamber
2 Evacuation pump
3 First roller (take-in/feeding roller)
4 Current collector
4A, 4B Bump of the current collector
5a, 5b, 5c, 5d, 5e Transportation roller
6a, 6b, 6c, 7a, 7b, 7c Cooling support
8 Second roller (take-in/feeding roller)
9 Vaporization source
9S Vaporization surface
10 Container
32 Heating device
33a, 33b, 33c, 33d Mask
34a, 34b, 34c, 34d Mask
31a, 31b, 31c, 31d Oxygen nozzle
50, 51, 52, 53, 54 Vapor deposition apparatus
101, 102, 103, 104, 202 Active material
101a, 101b First layer of the active material body
102a, 102b Second layer of the active material body
103a, 103b Third layer of the active material body
104a, 104b Fourth layer of the active material body
110, 120 Active material body
64 Negative electrode
68 Positive electrode
66 Positive electrode current collector
65 Positive electrode active material layer
61 Negative electrode current collector
62 Negative electrode active material layer
69 Separator
70 External case

### BEST MODE FOR CARRYING OUT THE INVENTION

The present invention relates to a method for producing an electrode for an electrochemical device including a current collector having a plurality of bumps having a height of 3 μm or grater and 10 μm or less on a surface thereof and also including an active material body which is formed on each of the bumps and has a stacked structure. According to the method, a first layer of each active material body which is located closest to the current collector is formed by performing oblique vapor deposition while moving the current collector in a direction in which the angle made by the normal to the current collector and a direction in which a vapor deposition material is incident on the surface of the current collector is decreased (hereinafter, the angle will be referred to as the “incidence angle of the vapor deposition material”; and the direction in which the vapor deposition material is incident will be referred to as the “incidence direction”). Also according to the method, a second layer is formed on at least a part of the first layer by causing the vapor deposition material to be incident in a direction inclined, with respect to the normal to the current collector, oppositely to the incidence direction for the first layer.

First, with reference to the drawings, advantages of the method will be described.

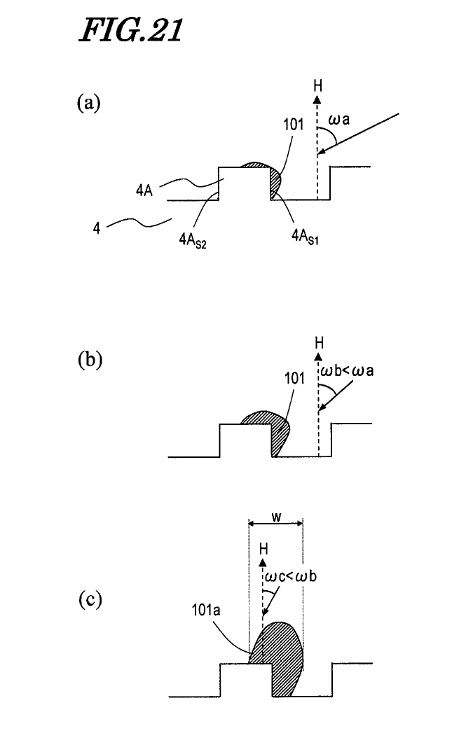

FIGS. 21(a) through 21(c) are schematic enlarged cross-sectional views illustrating an example of a vapor deposition step for forming a first layer of an active material body in a preferable embodiment according to the present invention. The vapor deposition step proceeds in the order of FIG. 21(a), FIG. 21(b) and FIG. 21(c).

According to this embodiment, during an initial period of the vapor deposition step, as shown in FIG. 21(a), a vapor deposition material is incident in a direction which makes a relatively large angle ωa with respect to the normal direction H to the current collector. At this point, the vapor deposition material is selectively incident on an incidence-side side surface 4Aₛ₁ and a top surface of a bump 4A of the current collector 4, and an active material 101 is grown. The vapor deposition material is unlikely to be deposited on a dent (groove) between the bumps 4A. The reason for this is that because the incidence angle ω is large, the dent is in the shadow of the bump 4A adjacent thereto and so the vapor deposition material is unlikely to be incident on the dent (shadowing effect).

Next, vapor deposition is performed while the current collector is moved in a direction in which the incidence angle ω is decreased (ωc<ωb<ωa). As a result, the active material 101 is deposited so as to cover the surface of the bump 4A, and thus the first layer 101a of the active material body is obtained.

During the formation of the first layer 101a of the active material body, the incidence angle ω of the vapor deposition material is changed as described above. Owing to this, the vapor deposition material can be selectively deposited so as to cover the surface of the bump 4A (the top surface and the vapor deposition material incidence-side side surface 4A_{S1}). Therefore, as compared with the case where the first layer is formed with a fixed incidence angle or the first layer is formed while the current collector is moved in a direction in which the incidence angle ω is increased, the contact area size between the surface of the current collector 4 and the first layer 101a of each active material body can be increased and so the adherence thereof can be more improved.

By contrast, although not shown, in the case where the first layer is formed while the current collector is moved in a direction in which the incidence angle ω is increased, the incidence angle ω is small during the initial period of the vapor deposition step, and so the shadowing effect is not sufficiently provided. As a result, the vapor deposition material is likely to be deposited on the dents of the current collector as well as on the bumps. By contrast, according to the method of this embodiment, as described above with reference to FIG. 21(a), the incidence angle ωa is sufficiently large during the initial period of the vapor deposition step, and so the active material is unlikely to be deposited on the dents of the current collector 4. There may be cases where the active material is deposited on the dents of the current collector 4 depending on the size of the bumps 4A and the incidence angle ωa. Even in such a case, the amount of the deposited active material is small. In addition, as shown in FIG. 21(c), during a final period of the vapor deposition step, the dent of the current collector 4 is in the shadow of the active material deposited on the bump 4A. For this reason, even though the incidence angle ωc is small, the active material is unlikely to be deposited on the dents of the current collector. Therefore, the space in which the active material bodies are allowed to expand can be obtained between the active material bodies with more certainty. In addition, the amount of the active material deposited on the dents can be decreased, and so the expansion stress applied on the current collector by the active material on the dents can be suppressed.

In this embodiment, the growth direction of the first layer 101a changes from a direction in which the inclination angle with respect to the normal H to the current collector is larger to a direction in which the inclination angle is smaller in accordance with the change of the incidence angle ω Therefore, even when the vapor deposition time is set to be long, the first layer 101a extends upward (a direction in which the active material body rises). For this reason, as compared with the case where the first layer is formed at a fixed incidence angle or the first layer is formed while the current collector is moved in a direction in which the incidence angle ω is increased, a width w of the first layer 101a in a plane parallel to the surface of the current collector 4 can be suppressed to be small, which allows a sufficiently large space to be made between adjacent first layers 101a more easily.

Since the first layer 101a is directed upward, the vapor deposition material for a second layer can be easily deposited on a part of the surface of the bump 4A which is not in contact with the first layer 101a (especially, a side surface 4Aₛ₂ of the bump 4A opposed to the side surface 4Aₛ₁). Owing to this, the contact area size can be increased, and so the adherence can be more improved, between the active material body and the surface of the bump 4A. It is preferable that the incidence direction of the vapor deposition material for forming the second layer is inclined, with respect to the normal H to the current collector, oppositely to the incidence direction thereof for forming the first layer 101a. Owing to this, the vapor deposition material can be deposited on the side surface 4Aₛ₂ of the bump 4A more certainly. The first layer and the second layer are formed so as to cover the surface of the bump, and then the active material is deposited in further layers when necessary to form an active material body. The obtained active material body has the first and second layers as an underlying layer, and so has a stronger adherence to the bump 4 of the current collector.

For forming the second layer, the incidence angle ω of the vapor deposition material may be kept the same or changed to be increased or decreased. Preferably, the second layer is formed while the current collector 4 is moved in a direction in which the incidence angle ω is increased. This allows a plurality of layers to be formed continuously on the current collector 4, which is sheet-like, in a chamber of the vapor deposition apparatus. The above manner of forming the second layer also has the following advantages.

Before the second layer is formed, the first layer is already formed on the bump of the current collector. Therefore, the shadowing effect during the formation of the second layer is larger than that in the vapor deposition step for forming the first layer. For this reason, when the second layer is formed while the incidence angle is decreased, the active material may not be deposited, undesirably, on a part of the side surface of the bump. This makes it difficult to cover the entirety of the surface of the bump with the active material, which may weaken the adherence. By contrast, when the second layer is formed while the incidence angle is increased, the active material can be deposited in a sufficient thickness on the side surface of the bump. Therefore, the adherence between the active material body and the side surface of the bump, as well as the top surface of the bump, can be effectively improved.

Regarding the first layer vapor deposition step, there is a problem that when vapor deposition is performed while the current collector is moved in a direction in which the incidence angle is increased, the amount of the active material deposited on the dent increases. By contrast, regarding the second layer vapor deposition step, the first layer is already formed on the bump of the current collector and so the shadowing effect is increased. Therefore, even though vapor deposition is performed while the current collector is moved in a direction in which the incidence angle is increased, the active material is unlikely to be deposited on the dent of the current collector. Accordingly, when the first layer is formed by vapor deposition while the current collector is moved in a direction in which the incidence angle is decreased and the second layer is formed by vapor deposition while the current collector is moved in a direction in which the incidence angle is decreased, the first and second layers can be continuously formed while the active material is suppressed from being deposited on the dent in both of the vapor deposition steps.

For forming the second and subsequent later layers, vapor deposition may be performed in a direction inclined, with respect to the normal to the current collector 4, in the same direction as the first layer 101a to form an active material body having a growth direction inclined in one direction. Alternatively, vapor deposition may be performed in oppositely inclined directions alternately to form an active material body having a growth direction extending in a zigzag manner in a direction away from the surface of the current collector.

Hereinafter, embodiments according to the present invention will be described more specifically.

### Embodiment 1

A method for producing an electrode for an electrochemical device (hereinafter, referred to simply as the “electrode”) in Embodiment 1 according to the present invention will be described. The electrode for an electrochemical device in this embodiment is a negative electrode for a lithium secondary cell using a silicon oxide as the active material.

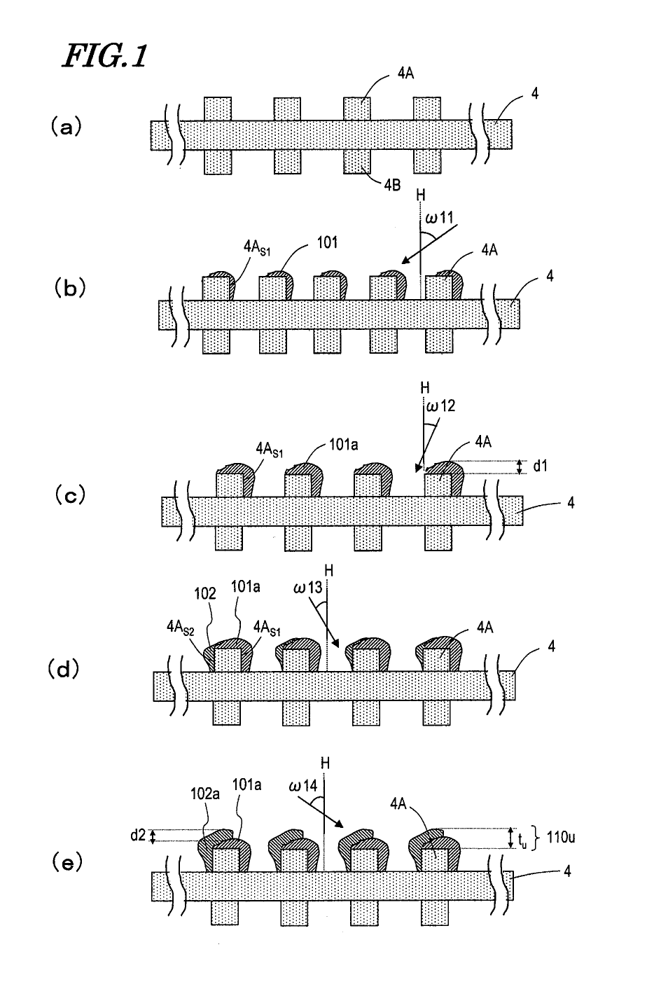

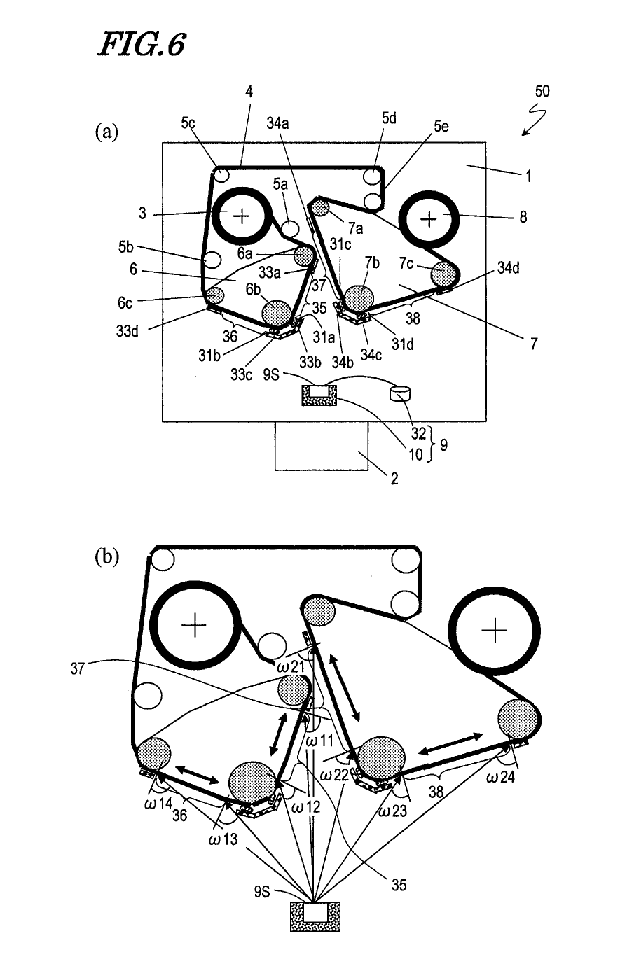

FIG. 1 though FIG. 5 are schematic cross-sectional views of steps illustrating a method for producing an electrode in this embodiment. FIG. 6(a) is a schematic cross-sectional view showing an example of a vapor deposition apparatus usable for the method in this embodiment, and FIG. 6(b) is a cross-sectional view illustrating an incidence angle ω of a vapor deposition material in the vapor deposition apparatus shown in FIG. 6(a).

<Structure of the Vapor Deposition Apparatus>

First, a vacuum vapor deposition apparatus used in this embodiment will be described. As shown in FIG. 6(a), a vacuum vapor deposition apparatus 50 includes a chamber 1, an evacuation pump 2 provided outside the chamber 1 for exhausting the chamber 1, and a gas introduction pipe (not shown) for introducing a gas such as oxygen gas or the like from the outside of the chamber 1 into the chamber 1. Provided in the chamber 1 are a vaporization source 9 from which the vapor deposition material is to be vaporized, first and second rollers 3 and 8 around which the sheet-like current collector 4 can be wound and held, transportation rollers 5a through 5e for transporting the substrate 4, cooling supports 6a through 6c and 7a through 7c for cooling and supporting the current collector 4, and nozzles 31a through 31d connected to the gas introduction pipe (not shown) for supplying gas to the surface of the current collector 4.

The vaporization source 9 includes a container 10 such as, for example, a crucible for accommodating the vapor deposition material and a heating device 32 for vaporizing the vapor deposition material. The vapor deposition material and the container 10 are structured to be detachable when necessary. As the heating device 32, for example, a resistance heating device, an induction heating device, an electron beam heating device or the like is usable. For performing vapor deposition, the vapor deposition material accommodated in the crucible 10 is heated by the heating device 32 to be vaporized from a top surface (vaporization surface) 9S of the crucible 10 and supplied to the surface of the current collector 4.

A part of a transportation path for transporting the current collector 4 which is between the cooling supports 6a and 6b, and a part thereof between the cooling supports 6b and 6c, respectively act as a first vapor deposition zone 35 and a second vapor deposition zone 36 in which vapor deposition is performed on the current collector 4. Similarly, a part between the cooling supports 7a and 7b and a part between the cooling supports 7b and 7c respectively act as a third vapor deposition zone 37 and a fourth vapor deposition zone 38 in which vapor deposition is performed on the current collector 4. In the vacuum vapor deposition apparatus 50, vapor deposition is performed on one surface of the current collector 4 in the first and second vapor deposition zones 35 and 36, and on the other surface of the current collector 4 in the third and fourth vapor deposition zones 37 and 38. Both ends of the vapor deposition zones 35, 36, 37 and 38 are defined by masks 33a through 33d and 34a through 34d.

In the vacuum vapor deposition apparatus 50, the current collector 4 is fed out from one of the first and second rollers 3 and 8, guided along the transportation path by the transportation rollers 5a through 5c and the cooling supports 6a through 6c and 7a through 7c, and taken in by the other of the first and second rollers 3 and 8. The current collector 4 which has been taken in is further fed out from the roller, which has taken in the current collector 4, when necessary and transported along the transportation path in the opposite direction to the above. In this manner, in this embodiment, the first and second rollers 3 and 8 may act either as a feeding roller or a take-in roller depending on the transportation direction. By repeating the transportation in a forward direction and a reverse direction, the vapor deposition step can be continuously performed a desired number of times.

<Method for Forming the Electrode>

First, as shown in FIG. 1(a), the current collector 4 having a plurality of bumps 4A and 4B formed in a regularly arranged manner on both surfaces of a sheet-like metal foil is formed. The material of the current collector 4 may be a metal material such as copper, nickel or the like.

Next, the active material bodies are formed on the current collector 4 using the vacuum vapor deposition apparatus 50 described above. The active material bodies are formed by causing the current collector 4 to run in the vapor deposition zones 35, 36, 37 and 38 in the chamber 1 and causing the vaporized vapor deposition material to be incident on the surface of the running current collector 4. In this embodiment, silicon, for example, is used as the vapor deposition material, and oxygen gas is supplied from the nozzles 31a through 31d to the corresponding vapor deposition zones 35, 36, 37 and 38 during the vapor deposition. This causes silicon to be reacted with oxygen gas, and the active material bodies formed of a silicon oxide are formed on the bumps 4A and 4B of the current collector 4.

Hereinafter, the step for forming the active material bodies will be described in more detail with an example of the active material bodies each formed of four layers.

First, the current collector 4 is set as being wound around the first roller 3. Then, the current collector 4 is fed out from the first roller 3 and transported to the vapor deposition zone 35. In the vapor deposition zone 35, while the current collector 4 is moved in a direction approaching the vaporization source 9 (vaporization surface 9S), the vaporized vapor deposition material (for example, silicon) is caused to be incident on the surface of the current collector 4 (first layer vapor deposition step). Thus, as shown in FIGS. 1(b) and 1(c), the first layer 101a of the active material body is obtained on each of the bumps 4A of the current collector 4.

The first layer vapor deposition step will be described in more detail. When the current collector 4 passes in the vicinity of a top end of the vapor deposition zone 35, as shown in FIG. 1(b), the incidence angle ω of the vapor deposition material is ω1 (FIG. 6(b)). At this point, silicon as the vapor deposition material reacts with oxygen gas jetted from the nozzle 31a on the surface of the current collector 4, and a silicon oxide 101 as an active material is selectively deposited on the bumps 4A. The silicon oxide is likely to be deposited on the top surface and the incidence-side side surface 4Aₛ₁ of each bump 4A on the surface of the current collector 4, and so is grown like a pillar on the bump 4A. By contrast, on the surface of the current collector 4, there are areas made which are in the shadow of the bumps 4A and the silicon oxide 101 growing like pillars and have no vapor deposition material incident thereon and so have no silicon oxide 101 deposited thereon (shadowing effect). In the example shown in FIG. 1(b), because of the shadowing effect, the vapor deposition material does not adhere to, and so the silicon oxide 101 is not grown on, dents between adjacent bumps 4A on the surface of the current collector 4.

As the current collector 4 is moved from the vicinity of the top end toward a bottom end of the vapor deposition zone 35, the incidence angle ω of the vapor deposition material decreases (see FIG. 6(b)). Herein, the “incidence angle ω” is the angle at which the vapor deposition material is incident on the vapor deposition zone 35 from the center of the vapor deposition surface 9S.

When the current collector 4 passes in the vicinity of the bottom end of the vapor deposition zone 35, as shown in FIG. 1(c), the incidence angle w of the vapor deposition material is ω12 (ω12<ω1). In this manner, the silicon oxide is grown like a pillar on each of the bumps 4A of the current collector 4, and the first layer 101a is obtained. The growth direction of the obtained first layer 101a is inclined with respect to the normal H to the current collector 4, and the inclination angle is changed so as to be larger on the side of the current collector and to become smaller in a direction away from the current collector.

Then, the current collector 4 is transported to the vapor deposition zone 36. In the vapor deposition zone 36, while the current collector 4 is moved in a direction away from the vaporization source 9 (vapor deposition surface 9S), the vaporized vapor deposition material is caused to be incident on the surface of the current collector 4 (second vapor deposition step). Thus, as shown in FIGS. 1(d) and 1(e), the second layer 102a of the active material body is formed on each of the bumps 4A of the current collector 4.

When the current collector 4 passes in the vicinity of a bottom end of the vapor deposition zone 36, as shown in FIG. 1(d), the incidence angle ω of the vapor deposition material is ω13. At this point, silicon as the vapor deposition material reacts with oxygen gas from the nozzle 31b, and a silicon oxide 102 as an active material is selectively deposited on the side surface 4A_{S2} of each of the bumps 4A and on each first layer 101a. On the surface of the current collector 4, there are areas made which are in the shadow of the bumps 4A and the first layers 101a on the adjacent bumps and have no vapor deposition material incident thereon and so have no silicon oxide 102 deposited thereon (shadowing effect). In the example shown in FIG. 1(d), because of the shadowing effect, the vapor deposition material does not adhere to, so the silicon oxide 102 is not grown on, the dents between adjacent bumps 4A on the surface of the current collector 4.

As the current collector 4 is moved from the vicinity of the bottom end toward a top end of the vapor deposition zone 36, the incidence angle ω of the vapor deposition material increases (see FIG. 6(b)). When the current collector 4 passes in the vicinity of the top end of the vapor deposition zone 36, as shown in FIG. 1(e), the incidence angle w of the vapor deposition material is ω14 (ω14>ω13). In this manner, the second layer 102a is formed on each first layer 101a on the current collector 4. The growth direction of the obtained second layer 102a is inclined with respect to the normal H to the current collector 4, and the inclination angle is changed so as to be smaller on the side of the current collector and to become larger in a direction away from the current collector.

Next, the current collector 4 is transported such that the vapor deposition material is incident on the opposite surface thereof, and the current collector 4 is transported to the vapor deposition zones 37 and 38 in this order.

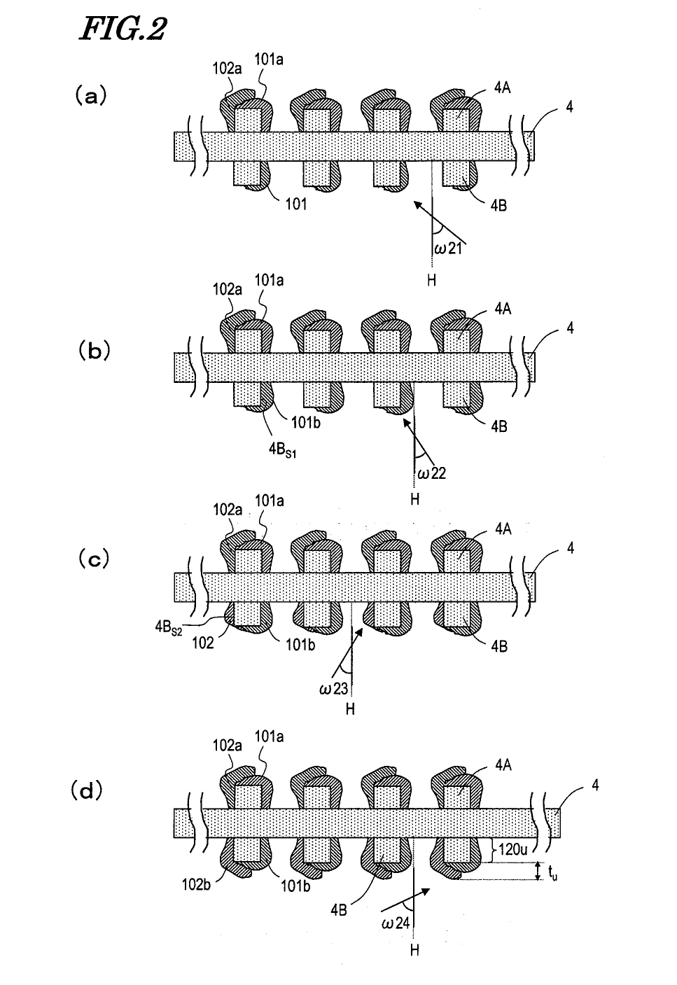

In the vapor deposition zone 37, while the current collector 4 is moved in a direction approaching the vaporization source 9, the vapor deposition material is caused to be incident on the surface of the current collector 4 opposite to the surface on which the first layers 101a and the second layers 102a are formed (hereinafter, referred to simply as the “bottom surface”) (first layer vapor deposition step). This step is substantially the same as the first layer vapor deposition step for forming the first layers 101a. At a top end of the vapor deposition zone 37, as shown in FIG. 2(a), the vapor deposition material is incident on the current collector 4 at an angle of ω21, and the silicon oxide 101 is selectively deposited on each of the bumps 4B of the current collector 4. As the current collector 4 approaches the vaporization source 9, the incidence angle ω decreases. At a bottom end of the vapor deposition zone 37, the incidence angle ω is ω22. Thus, as shown in FIG. 2(b), first layers 101b are formed at certain intervals so as to cover top surfaces and side surfaces 4Bₛ₁ of the bumps 4B.

In the vapor deposition zone 38, while the current collector 4 is moved in a direction away from the vaporization source 9, the vapor deposition material is caused to be incident on the bottom surface of the current collector 4 (second vapor deposition step). This step is substantially the same as the second vapor deposition step for forming the second layers 102a. At a bottom end of the vapor deposition zone 38, as shown in FIG. 2(c), the vapor deposition material is incident on the current collector 4 at an angle of ω23, and the silicon oxide 102 is selectively deposited on a side surface 4Bₛ₂ of each of the bumps 4A and on each first layer 101b. As the current collector 4 is moved away from the vaporization source 9, the incidence angle ω increases. At a top end of the vapor deposition zone 38, the incidence angle ω is ω24. Thus, as shown in FIG. 2(d), the second layers 102b are formed at certain intervals on the first layers 101b respectively.

In this manner, on both surfaces of the current collector 4, the first and second layers 101a, 101b, 102a and 102b are formed. Then, the current collector 4 is once taken in by the second roller 8.

Next, the current collector 4 is fed out from the second roller 8 and transported in a direction opposite to the direction in the first and second vapor deposition steps described above with reference to FIGS. 1 and 2, such that the current collector 4 passes the vapor deposition zones 38, 37, 36 and 35 in this order. In this specification, regarding the transportation path for the current collector 4 including the first and second rollers 3 and 8 and the plurality of vapor deposition zones located therebetween, the transportation direction for the current collector 4 used for forming the first layer is referred to as the “forward direction”, and the opposite transportation direction thereto is referred to as the “reverse direction”.

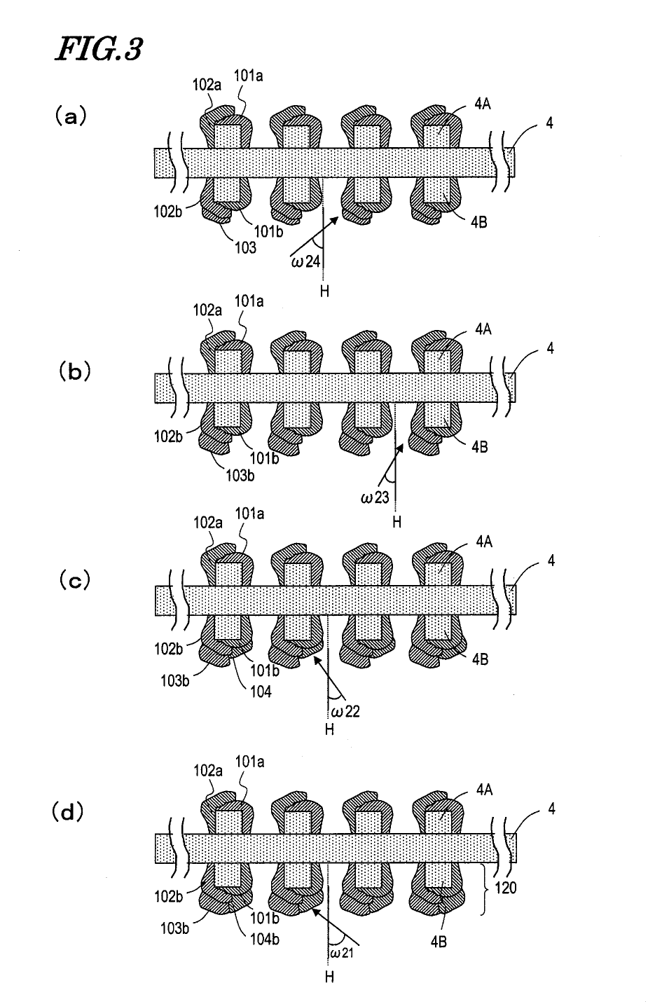

In the vapor deposition zone 38, while the current collector 4 is moved in a direction approaching the vaporization source 9, the vapor deposition material is caused to be incident on the bottom surface of the current collector 4. Thus, as shown in FIGS. 3(a) and 3(b), an active material 103 is deposited on the second layers 102b to form third layers 103b (third vapor deposition step). In this vapor deposition step, as the current collector 4 approaches the vaporization source 9, the incidence angle ω decreases from ω24 to ω23. The third layers 103b are formed on the second layers 102b and have a growth direction inclined, with respect to the normal H to the current collector 4, in the same direction as the growth direction of the second layers 102b.

In the vapor deposition zone 37, while the current collector 4 is moved in a direction away from the vaporization source 9, the vapor deposition material is caused to be incident on the bottom surface of the current collector 4. As shown in FIGS. 3(c) and 3(d), an active material 104 is deposited on the bumps 4B to form fourth layers 104b (fourth vapor deposition step). In this manner, active material bodies 120 each formed of four layers are obtained. In this vapor deposition step, as the current collector 4 becomes farther away from the vaporization source 9, the incidence angle w increases from ω22 to ω21. In the example shown in the figures, the fourth layers 104b are formed on the first layers 101b. Depending on the incidence angle w, the fourth layers 104b may be formed on the first and third layers 101b and 103b, or may be formed to be in contact only with the third layers 103b. The fourth layers 104b have a growth direction inclined, with respect to the normal H to the current collector 4, in the same direction as the growth direction of the first layers 101b.

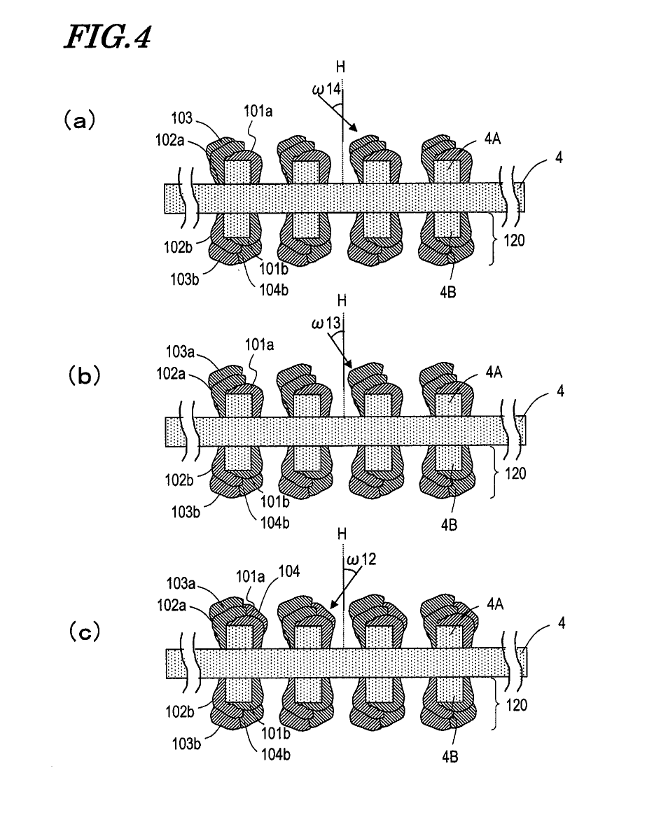

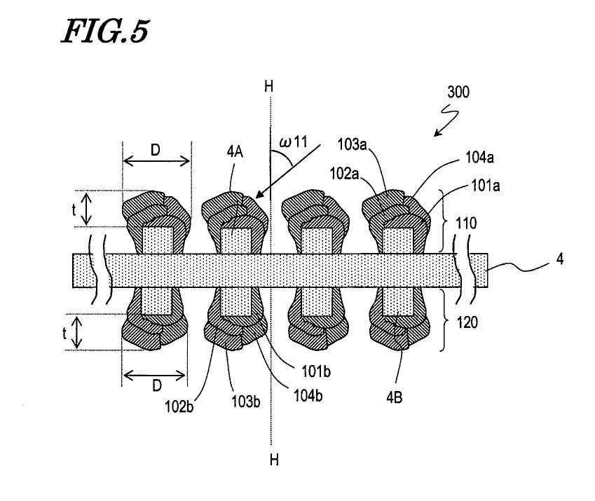

After the fourth layers 104b are formed, the current collector 4 is transported such that the vapor deposition material is incident on the opposite surface thereof, and the current collector 4 is transported to the vapor deposition zone 36. In the vapor deposition zone 36, while the current collector 4 is moved in a direction approaching the vaporization source 9, the vapor deposition material is caused to be incident on the top surface of the current collector 4. As shown in FIGS. 4(a) and 4(b), the active material 103 is deposited on the second layers 102a to form third layers 103a (third vapor deposition step). In this vapor deposition step, as the current collector 4 approaches the vaporization source 9, the incidence angle ω decreases from ω14 to ω13. The third layers 103a are formed on the second layers 102a and have a growth direction inclined, with respect to the normal H to the current collector 4, in the same direction as the growth direction of the second layers 102a.

In the vapor deposition zone 35, while the current collector 4 is moved in a direction away from the vaporization source 9, the vapor deposition material is caused to be incident on the top surface of the current collector 4. As shown in FIGS. 4(c) and 5, the active material 104 is deposited on the bumps 4A to form fourth layers 104a (fourth vapor deposition step). In this manner, active material bodies 110 each formed of four layers are obtained. In this vapor deposition step, as the current collector 4 becomes farther away from the vaporization source 9, the incidence angle ω increases from ω12 to ω1. Like the fourth layers 104b formed on the bottom surface of the current collector 4, the fourth layers 104a may be formed on the first and third layers 101a and 103a, or may be formed to be in contact only with the third layers 103a. The fourth layers 104a have a growth direction inclined, with respect to the normal H to the current collector 4, in the same direction as the growth direction of the first layers 101a.

In this manner, an electrode 300 in which the active material bodies 110 and 120 each formed of four layers are located at certain intervals on both surfaces of the current collector 4 is produced.

With the above-described method, the active material bodies 110 and 120 each formed of four layers are formed. Alternatively, active material bodies each formed of five or more layers may be formed by transporting the current collector 4 in the forward direction and the reverse direction a plurality of times alternately. Still alternatively, active material bodies each formed of two layers may be formed by transporting the current collector 4 once in the forward direction. In this specification, the “layer” of the active material bodies 110 and 120 is a portion formed by causing the vapor deposition material to be incident in a direction inclined in one direction with respect to the normal H to the current collector 4 while the current collector 4 passes one vapor deposition zone.

The vapor deposition apparatus usable in this embodiment is not limited to the vapor deposition apparatus 50 shown in FIG. 6 and may be anything which can perform the first layer vapor deposition step described above. For example, a vapor deposition apparatus including five or more vapor deposition zones and allows more layers to be formed on both surfaces of the current collector 4 by transporting the current collector 4 only once in the forward direction may be used. Alternatively, a vapor deposition apparatus having a structure for forming a plurality layers on one surface of the current collector 4 without transporting the current collector 4 such that the vapor deposition material is incident on the opposite surface thereof on the transportation path may be used.

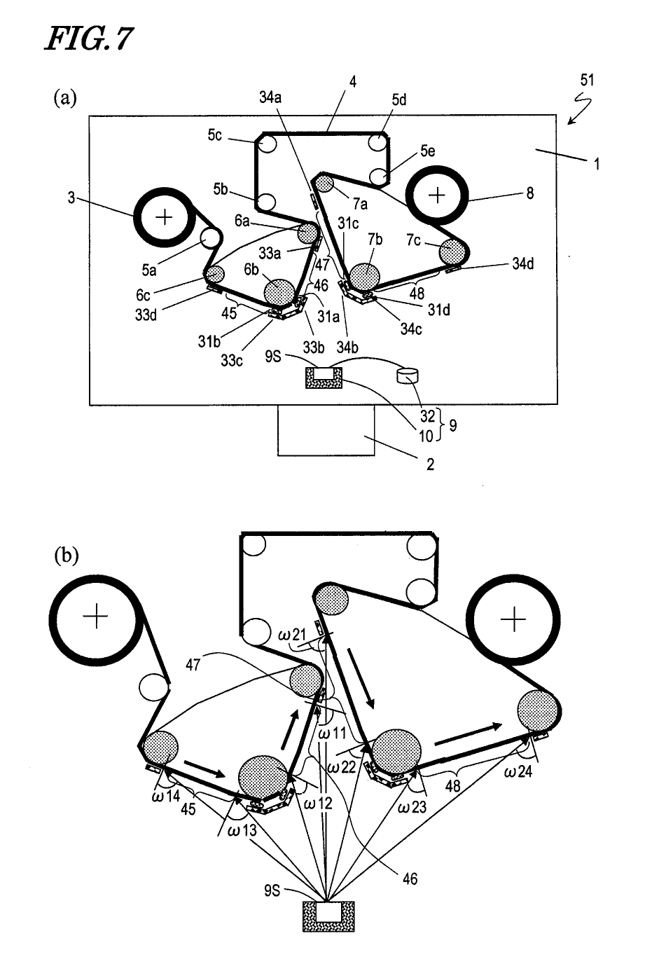

FIG. 7(a) is a schematic cross-sectional view showing a structure of another vapor deposition apparatus usable in the method of this embodiment. FIG. 7(b) is a cross-sectional view illustrating the incidence angle ω of the vapor deposition material in the vapor deposition apparatus in FIG. 7(a). For the sake of simplicity, elements substantially the same as those of the apparatus shown in FIGS. 6(a) and 6(b) bear identical reference numerals thereto and descriptions thereof will be omitted.

A vapor deposition apparatus 51 includes four vapor deposition zones 45, 46, 47 and 48 between the first and second rollers 3 and 8 on the transportation path. In all of these vapor deposition zones, vapor deposition is performed on one surface of the current collector 4. Accordingly, after the current collector 4 is fed out from the first roller 3 until the current collector 4 is taken in by the second roller 8, vapor deposition step (i) of performing vapor deposition on the surface of the current collector 4 while the incidence angle ω is decreased, and vapor deposition step (ii) of performing vapor deposition on the surface of the current collector 4 while the incidence angle ω is increased, are repeated twice alternately. Thus, active material bodies each formed of four layers can be formed. Then, the current collector 4 may be fed out from the second roller 8 in the opposite direction to form active material bodies formed of a greater number of layers. With a structure for causing the steps (i) and (ii) to be repeated twice or a greater number of times while the current collector 4 is transported once in the forward direction, active material bodies formed of a plurality of stages having alternately opposite growth directions with respect to the normal H to the current collector 4 can be formed. The vapor deposition zones 45 through 48 are structured such that thicknesses tp₁ and tp₄ of the active material bodies formed in the vapor deposition zones 45 and 48 are respectively ½ of thicknesses tp₂ and tp₃ of the active material bodies formed in the vapor deposition zones 46 and 47. In addition, for example, soon after the second vapor deposition step, the third vapor deposition step is performed. Therefore, a surface oxide film or the like is prevented from being formed on the second layers. In this manner, a big change of the composition of the silicon oxide (SiOₓ, 0<x<2) is suppressed at an interface of two layers which form one stage. Therefore, the active material can be suppressed from being delaminated from the interfaces by the expansion and contraction at the time of charge/discharge. Thus, the reliability can be improved.

It is preferable that the vapor deposition apparatus used in this embodiment has a vapor deposition zone including a planar transportation zone in which the current collector 4 is transported such that the vapor deposition surface of the current collector 4 is planar, such as the vapor deposition zones 35 through 38 or 45 through 48 in the vapor deposition apparatus 50 or 51. Namely, in such a vapor deposition apparatus, in the cross-sections shown in the figures, the current collector 4 is transported linearly. With such a structure, the number of vaporized and flying particles and the amount of oxygen supplied from the nozzle change in accordance with the distance between the vapor deposition zone and the vaporization surface 9S. More specifically, at a bottom end of the vapor deposition zone which has a short distance from the vaporization surface 9S, SiOₓ having a low ratio of oxygen x is formed. As the distance from the vaporization surface 9S increases, SiOₓ having a higher ratio of oxygen x is formed. Therefore, the oxygen ratio x of obtained active material bodies 201a is high on the side of the current collector and is gradually decreased along the thickness direction. As the oxygen ratio x is lower, the lithium occluding amount is larger and so the volume expansion ratio by occlusion of lithium is higher. Owing to this, on the current collector side of the active material bodies 201a, the volume expansion can be suppressed to prevent the reduction of the adherence; whereas on the top surface side of the active material bodies 201a, a certain lithium occluding amount can be obtained with certainty. This is advantageous because the charge/discharge capacity can be kept large while the active material bodies 201a can be suppressed from being delaminated.

The structure of the electrode in this embodiment is not limited to the structure of the electrode 300. For example, in this embodiment, it is sufficient that each active material layer in the electrode has a stacked structure including the first layers 101a and 101b formed by performing vapor deposition while the incidence angle w is decreased and at least one layer formed thereon. Owing to this, as described above with reference to FIG. 21, the adherence of the bumps 4A and 4B with the active material bodies can be improved while a sufficiently large space can be obtained between the active material bodies with certainty.

It is preferable that the active material bodies have a structure in which a plurality of portions having alternately opposite growth directions with respect to the normal H to the current collector 4 (referred to as the “stages”) are stacked. Hereinafter, with reference to the figures, a structure of the active material bodies will be described with an example of an active material body formed of four layers and an active material body formed of six layers.

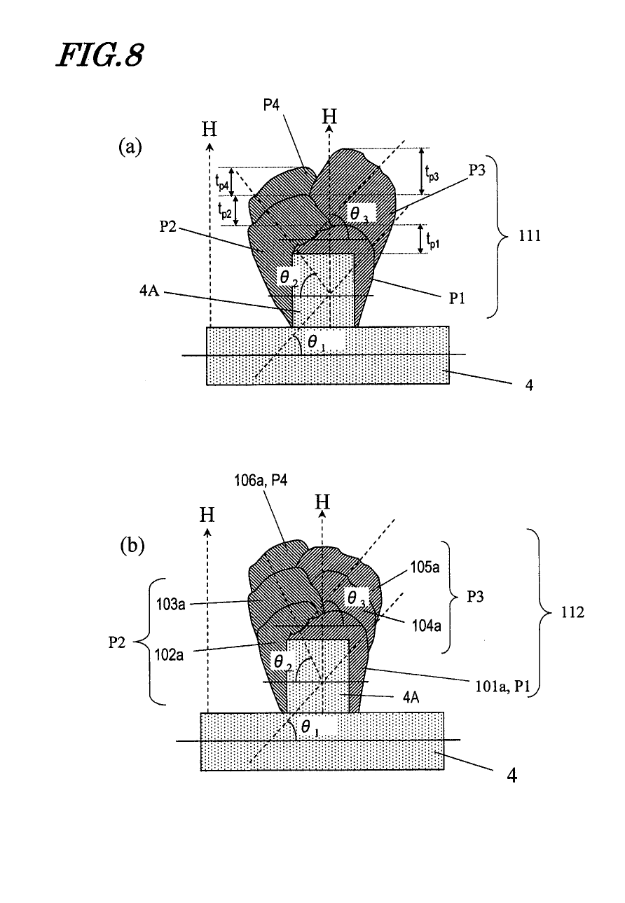

FIG. 8(a) is a schematic cross-sectional view showing an active material body 111 formed of four layers, which is formed by substantially the same method as described above using the vapor deposition apparatus 51. FIG. 8(b) is a schematic cross-sectional view showing an active material body 112 formed of six layers, which is formed by substantially the same method as described above using the vapor deposition apparatus 50.

As shown in FIG. 8(a), the active material body 111 includes first through fourth stages P1 through P4 respectively formed of the first through fourth layers. The thickness tp₁ of the first stage P1 and the thickness tp₄ of the fourth stage P4 are respectively ½ of the thickness t_{P2} of the second stage P2 and the thickness tp₃ of the third stage P3 formed therebetween. In this manner, in the case where vapor deposition is performed while the transportation direction of the current collector 4 is switched using the vapor deposition apparatus 51, the thickness of a portion formed of the first stage P1 and the thickness of the final layer formed are respectively ½ of the thicknesses of the stages formed therebetween.

As shown in FIG. 8(b), the active material body 112 formed while the transportation direction of the current collector 4 is switched using the vapor deposition apparatus 50 includes a first stage P1 formed of a first layer 101a having a growth direction inclined with respect to the normal H to the current collector 4 (inclination angle θ₁), a second stage P2 having a growth direction inclined, with respect to the normal H to the current collector 4, oppositely to the first stage P1 (inclination angle θ₂) and formed of second and third layers 102a and 103a, a third stage P3 having a growth direction inclined, with respect to the normal H to the current collector 4, in the same direction as the first stage P1 (inclination angle θ₃) and formed of fourth and fifth layers 104a and 105a, and a fourth stage P4 having a growth direction inclined, with respect to the normal H to the current collector 4, in the same direction as the first stage P1 and formed of a sixth layer 106a. The first through fourth stages P1 through P4 are stacked. The inclination angles θ₁ through θ₃ are each an average value of the inclination angles of the growth directions of each layer with respect to the normal H to the current collector 4. Typically, the inclination angles θ₁ through θ₃ are each an inclination angle at the position of ½ of the thickness of each layer in the shown cross-section.

There is no specific limitation on the number of portions included in the active material body. For example, it is preferable that an active material body having a height of 10 μm or greater along the normal H to the current collector 4 includes at least four portions. For example, it is preferable that an active material body having a height of 20 μm or greater along the normal H to the current collector 4 includes at least eight portions. This can suppress the width (diameter) of the active material body from increasing in a direction away from the current collector 4, and so a space between the active material bodies in which the active material bodies are allowed to expand can be obtained more certainly.

Where the thickness of each portion is large, there may be cases where a bent portion is formed at the border between adjacent portions of the active material body in correspondence with the change of the growth direction, depending on the incidence angle ω. Where the number of portions is N, the number of the bent portions is N−1. In the case of an active material body formed of four stages P1 through P4, a bent portion is formed between adjacent stages of the four stages included in the active material body. Therefore, it is preferable that an active material body having a height of, for example, 10 μm or greater along the normal H to the current collector 4 has at least three bent portions. It is preferable that an active material body having a height of, for example, 20 μm or greater along the normal H to the current collector 4 has at least seven bent portions.

In the vapor deposition apparatus 50, the first and third vapor deposition zones 35 and 37 respectively for forming the first layers 101a and 101b on the top and bottom surfaces of the current collector 4 are located while facing each other above the vaporization surface 9S. It is preferable that the first and third vapor deposition zones 35 and 37 are inclined oppositely to each other with respect to the normal direction to the vaporization surface 9S, and that the inclination angles have generally equal absolute values. With such a structure, the first layers 101a and 101b are formed on the top and bottom surfaces of the current collector 4 at the same time, and the growth direction of the first layer 101a and the growth direction of the first layer 101b are generally symmetrical to each other. For example, the first layer 101a grows in a direction inclined rightward with respect to the normal H to the current collector 4, whereas the first layer 101b grows in a direction inclined leftward with respect to the normal H to the current collector 4. Accordingly, the expansion stresses generated on the top and bottom surfaces of the current collector 4 can cancel each other, and so the current collector 4 can be suppressed from being deformed by charge/discharge.

The vapor deposition apparatus 50 includes a single vaporization source 9, and a plurality of vapor deposition zones are located in a range in which the vapor deposition material can reach from the vaporization source 9. This is advantageous in realizing a highly productive step with a simple structure of the apparatus.

Hereinafter, with reference to FIGS. 1 through 5, 6(a) and 6(b) again, a method for producing an electrode in this embodiment will be described in more detail.

<Production of the Current Collector>

First, as shown in FIG. 1(a), on a surface of a copper alloy foil having a thickness of 18 μm, a plurality of bumps 4A are formed by machining to obtain the current collector 4. In the shown cross-section (cross-section perpendicular to the current collector 4 and including the incidence direction ω), the height of each bump 4A is 6 μm and the width thereof is 20 μm. The interval between adjacent bumps 4A is 20 μm.

### <Formation of the First Layers of the Active Material Bodies>

The obtained current collector 4 is set to the first roller 3 in the vapor deposition apparatus 50 shown in FIG. 2. The inside of the chamber 1 of the vapor deposition apparatus 50 is put into an oxygen atmosphere having a pressure of, for example, 0.02 Pa.

Next, in the vapor deposition zone 35 located between the cooling supports 6a and 6b, the current collector 4 is moved in a direction approaching the vaporization source 9. At this point, an active material such as, for example, silicon (scrapped silicon; having a purity of 99.999%) or tin is heated by the heating apparatus (for example, an electron beam) 32 to be vaporized from the vaporization source 9.

At the top end of the vapor deposition zone 35, namely, in the vicinity of the mask 1a, as shown in FIG. 1(b), the vaporized particles are incident on the top surface of the current collector 4 at an incidence angle of ω11. The incidence angle ω11 is, for example, 75 degrees. The vaporized particles react with oxygen supplied from the nozzle 31a, and thus the active material 101 having a composition of SiOₓ (a silicon oxide) grows on the bumps 4A of the current collector 4.

Then, along with the movement of the current collector 4, the silicon oxide 101 grows while the incidence angle ω of the vaporized particles is decreased from all (75°). At the bottom end of the vapor deposition zone 35, as shown in FIG. 1(c), the vaporized particles are incident at an incidence angle of ω12. The incidence angle ω12 is, for example, 62 degrees. In this manner, the first layers (thickness d1: for example, 0.2 μm) 101a formed of a silicon oxide are obtained. The thickness d1 of the first layers 101a is the thickness from the top surface of the bumps 4A along the normal H to the current collector 4.

In the vapor deposition zone 35, the number of vaporized and flying particles and the amount of oxygen supplied from the nozzle 31a change in accordance with the distance from the vaporization surface 9S. Accordingly, in a part of the vapor deposition zone 35 which has a short distance from the vaporization surface 9S (in the vicinity of the bottom end), a silicon oxide (SiOₓ) having a low oxygen ratio x is formed. As the distance from the vaporization surface 9S increases, a silicon oxide (SiOₓ) having a higher oxygen ratio x is formed. As a result, the oxygen ratio x of the obtained first layers 101a is high on the side of the current collector and is decreased along the thickness direction.

At the same time as the step of forming the first layers 101a is performed, the following is performed in the vapor deposition zone 37 located to be generally symmetrical to the vapor deposition zone 35 with respect to the normal to the vaporization surface 9S. The current collector 4 is moved in a direction approaching the vaporization source 9, and thus the first layers (thickness: for example, 0.2 μm) 101b are formed on the bumps 4B formed on the bottom surface of the current collector 4 as shown in FIGS. 2(a) and 2(b). The step of forming the first layers 101b is substantially the same as the step of forming the first layers 101a. The incidence angle ω21 at the top end of the vapor deposition zone 35 is 75 degrees, and the incidence angle ω22 at the bottom end thereof is 62 degrees.

In the initial period of the first layer vapor deposition step of forming the first layers 101a and 101b, the incidence angles ω11 and ω21 of the vapor deposition material are each preferably 60 degrees or greater and 75 degrees or less, and more preferably 70 degrees or greater and 75 degrees or less. When each of the incidence angles ω11 and ω21 exceeds 75 degrees, the inclination from the normal H to the current collector 4 is too large and so an underlying layer for covering the side surfaces of the bumps 4A and 4B is unlikely to be formed by the shadowing effect. As a result, the contact area size between the current collector 4 and the first layers 101a and 101b is small, and so the adherence therebetween is reduced. When each of the incidence angles ω11 and ω21 is smaller than 60 degrees, the silicon oxide 101 may undesirably be grown also on the dents between the bumps 4A and 4B. For this reason, a sufficiently large space cannot be obtained between the active material bodies, and so the current collector may undesirably be wrinkled by the expansion at the time of charge. By contrast, in the final period of the first layer vapor deposition step, the incidence angles ω12 and ω22 of the vapor deposition material are each preferably 45 degrees or greater and 70 degrees or less, and more preferably 60 degrees or greater and 70 degrees or less. When each of the incidence angles ω12 and ω22 is smaller than 45 degrees, the active material bodies grow to become thicker along the thickness direction (as being away from the current collector 4), which decreases the size of the space between the bumps. When each of the incidence angles ω12 and ω22 exceeds 70 degrees, the size of the area in which vapor deposition material can be deposited is decreased to reduce the productivity of the electrode. The incidence angles ω11, ω12, ω21 and ω21 are adjusted in accordance with the positions of the masks located between the vaporization surface 9S and the vapor deposition zones 35 and 37, and the inclination angles of the vapor deposition zones 35 and 37.

Next, in the vapor deposition zone 36 located between the cooling supports 6b and 6c, the current collector 4 is moved in a direction away from the vaporization source 9.

At the bottom end of the vapor deposition zone 36, namely, in the vicinity of the mask 11c, as shown in FIG. 1(d), the vaporized particles are incident on the top surface of the current collector 4 at an incidence angle of ω13. The incidence angle ω13 is, for example, 45 degrees. The vaporized particles react with oxygen supplied from the nozzle 31b, and thus the active material 101 having a composition of SiOₓ (a silicon oxide) grows on the side surface 4Aₛ₂ of the current collector 4 and the first layers 101a.

Then, along with the movement of the current collector 4, the silicon oxide 102 grows while the incidence angle ω of the vaporized particles is increased from ω13 (62°). At the top end of the vapor deposition zone 36, as shown in FIG. 1(e), the vaporized particles are incident at an incidence angle of ω14. The incidence angle ω14 is, for example, 75 degrees. In this manner, the second layers (thickness d2: for example, 0.2 μm) 102a formed of a silicon oxide are obtained. The thickness d2 of the second layers 102a is the thickness from the apex of the underlying layer (here, the first layers 101a), namely, the position which is farthest from the current collector 4, along the normal H to the current collector 4.

In the vapor deposition zone 36 also, the number of vaporized and flying particles and the amount of oxygen supplied from the nozzle 31b change in accordance with the distance from the vaporization surface 9S. Namely, as the distance from the vaporization surface 9S increases, a silicon oxide (SiOₓ) having a higher oxygen ratio x is formed. As a result, the oxygen ratio x of the obtained second layers 102a is low on the side of the current collector and is increased along the thickness direction.

At the same time as the step of forming the second layers 102a is performed, the following is performed in the vapor deposition zone 38 located to be generally symmetrical to the vapor deposition zone 36 with respect to the normal to the vaporization surface 9S. The current collector 4 is moved in a direction away from the vaporization source 9, and thus the second layers (thickness: for example, 0.2 μm) 102b are formed on the bumps 4B formed on the bottom surface of the current collector 4 as shown in FIGS. 2(c) and 2(d). The step of forming the second layers 102b is substantially the same as the step of forming the second layers 102a. The incidence angle ω23 at the bottom end of the vapor deposition zone 38 is 62 degrees, and the incidence angle ω24 at the top end thereof is 75 degrees.

In this manner, an underlying layer 110u formed of the first layer 101a and the second layer 102b is formed on each bump 4A on the top surface of the current collector 4. An underlying layer 120u formed of the first layer 101b and the second layer 102b is formed on each bump 4B on the bottom surface of the current collector 4. A thickness tᵤ of each of the underlying layers 110u and 120u (the thickness along the normal H to the current collector 4) is preferably 0.1 μm or greater and 3 μm or less. When the thickness tᵤ of each of the underlying layers 110u and 120u is 0.1 μm or greater, the adherence between the layer deposited on the underlying layer 110u, 120u and the current collector 4 can be obtained more effectively. When the thickness tᵤ of each of the underlying layers 110u and 120u is 3 μm or less, the width of each active material body can be suppressed from increasing in the thickness direction. Therefore, the rupture or delamination of the active material, which would be otherwise caused due to the expansion at the time of charge, can be prevented.

Then, the current collector 4 provided with the underlying layers 110u and 120u is once taken in by the second roller 8.

Next, the current collector 4 is transported from the second roller 8 toward the first roller 3. In the vapor deposition zone 38 located between the cooling supports 7d and 7c, the current collector 4 fed out from the second roller 8 is moved in a direction approaching the vaporization source 9.

At the top end of the vapor deposition zone 38, namely, in the vicinity of the mask 34d, as shown in FIG. 3(a), the vaporized particles are incident on the bottom surface of the current collector 4 at an incidence angle of ω24 (75°). The vaporized particles react with oxygen supplied from the nozzle 31d, and thus the active material 103 having a composition of SiOₓ (a silicon oxide) grows on the underlying layers 120u.

Then, along with the movement of the current collector 4, the silicon oxide 103 grows while the incidence angle ω of the vaporized particles is decreased from ω24 (75°). At the bottom end of the vapor deposition zone 38, as shown in FIG. 3(b), the vaporized particles are incident at an incidence angle of ω23 (62°). In this manner, the third layers (thickness d1: for example, 0.2 μm) 103b formed of a silicon oxide are obtained.

As described above, in the vapor deposition zone 38, the number of vaporized and flying particles and the amount of oxygen supplied from the nozzle 31d change in accordance with the distance from the vaporization surface 9S. As the distance from the vaporization surface 9S increases, a silicon oxide (SiOₓ) having a higher oxygen ratio x is formed. As a result, the oxygen ratio x of the obtained third layers 103b is high on the side of the current collector and is decreased along the thickness direction.

During the above step, the following is performed in the vapor deposition zone 36. The current collector 4 is moved in a direction approaching the vaporization source 9, and thus the third layers (thickness: for example, 0.2 μm) 103a are formed also on the underlying layer 110u covering the bumps 4A on the top surface of the current collector 4 as shown in FIGS. 4(a) and 4(b). The step of forming the third layers 103a is substantially the same as the step of forming the third layers 103b. The incidence angle ω14 at the top end of the vapor deposition zone 36 is 75 degrees, and the incidence angle ω13 at the bottom end thereof is 62 degrees.

Next, in the vapor deposition zone 37 located between the cooling supports 7b and 7a, the current collector 4 is moved in a direction away from the vaporization source 9.

At the bottom end of the vapor deposition zone 37, namely, in the vicinity of the mask 34b, as shown in FIG. 3(c), the vaporized particles are incident on the bottom surface of the current collector 4 at an incidence angle of ω22)(62°). The vaporized particles react with oxygen supplied from the nozzle 31c, and thus the active material 104 having a composition of SiOₓ (a silicon oxide) grows on the third layers 103b formed on the bumps 4B of the current collector 4.

Then, along with the movement of the current collector 4, the silicon oxide 104 grows while the incidence angle ω of the vaporized particles is increased from ω22 (62°). At the top end of the vapor deposition zone 37, as shown in FIG. 3(d), the vaporized particles are incident at an incidence angle of ω21 (75°). In this manner, the fourth layers (thickness d2: for example, 0.2 μm) 104b formed of a silicon oxide are obtained.

In the vapor deposition zone 37 also, the number of vaporized and flying particles and the amount of oxygen supplied from the nozzle 31d change in accordance with the distance from the vaporization surface 9S. As the distance from the vaporization surface 9S increases, a silicon oxide (SiOₓ) having a higher oxygen ratio x is formed. As a result, the oxygen ratio x of the obtained fourth layers 104b is low on the side of the current collector and is increased along the thickness direction.

During the above step, the following is performed in the vapor deposition zone 35. The current collector 4 is moved in a direction away from the vaporization source 9, and thus the fourth layers (thickness: for example, 0.2 μm) 104a are formed on the bumps 4A formed on the top surface of the current collector 4 as shown in FIGS. 4(c) and 5. The step of forming the fourth layers 104a is substantially the same as the step of forming the fourth layers 104b. The incidence angle ω12 at the bottom end of the vapor deposition zone 35 is 45 degrees, and the incidence angle ω11 at the top end thereof is 75 degrees.

In this manner, the active material bodies 110 and 120 each formed of four layers are formed as shown in FIG. 5.

In this embodiment, there is no specific limitation on the material of the current collector 4. A metal material containing at least one element selected from copper, nickel and titanium is preferable. An alloy material containing any of these elements as a main component is also usable. It is especially preferable to use copper or a copper alloy, which is highly bendable and expandable and is not reactable with lithium. For example, a metal foil such as an electrolytic copper foil, an electrolytic copper alloy foil, an electrolytic copper foil treated with roughening, a rolled copper foil treated with roughening or the like is usable. Preferably, such a metal foil is a ruggedness foil having an arithmetic average roughness Ra of about 0.3 to 5.0 μm. The arithmetic average roughness Ra is defined by the Japanese Industrial Standards (JIS B0601-1994), and can be measured by, for example, a surface roughness meter or the like. When the current collector 4 is produced by forming bumps 4A and 4B on such a ruggedness foil, the surface roughness of the bumps 4A and 4B is increased, and so the adhering strength between the current collector 4 and the active material bodies 110 and 120 can be further increased.

The height of the bumps 4A and 4B formed on the current collector 4 is preferably 3.0 μm or greater and 10 μm or less. With such a height, a sufficiently large space can be provided between the active material bodies 110 and 120 more certainly. The bumps 4A and 4B may be formed by providing a regular ruggedness pattern on a surface of the metal foil by a resist method, a plating method or a machining method. There is no specific limitation on the thickness of a part of the current collector 4 on which the bumps 4A and 4B are not formed, but is, for example, 6 μm or greater and 50 μm or less.

Regarding the bumps 4A and 4B regularly formed on the surfaces of the current collector 4, the interval between adjacent bumps is preferably 5 μm or greater and 50 μm or less. When the interval is 50 μm or less, the active material can be selectively vapor-deposited on the surface of the bumps 4A and 4B more certainly, using the shadowing effect. When the interval is 5 μm or greater, the active material can be vapor-deposited on the entirety of the side surface of the bumps 4A and 4B as well as on the top surface thereof. Therefore, the contact area size between the active material bodies and the bumps 4A and 4B can be sufficiently large, and so the adhering strength between the bumps 4A and 4B and the active material bodies can be increased more effectively.

In order to increase the contact area size between the electrolysis and the active material as well as to alleviate the stress caused by the expansion of the active material, it is desirable that the active material layer formed of the active material bodies 110 or 120 has a predetermined porosity. The porosity P of the active material layer can be easily found from the weight of the active material layer deposited on a certain area size of the current collector 4, the thickness of the active material layer, and the density of the active material. In this embodiment, the “thickness t of the active material layer” is, as shown in FIG. 5, the average value of the heights t of the plurality of active material bodies 110 or 120, included in the active material layer, along the normal H to the current collector 4 from the top surface of the bumps 4A or 4B of the current collector 4. With a porosimeter using gas adsorption or mercury injection, the porosity P of the active material layer can be measured more accurately.

In this embodiment, the porosity P of the active material layer is preferably 10% or greater and 70% or less, and more preferably 30% or greater and 60% or less. When the porosity P is 10% or greater, the stress caused by the expansion and contraction of the pillar-like particles can be sufficiently alleviated. Therefore, the contact area size between each active material body and the electrolysis can be sufficiently large. Even an active material layer having the porosity P exceeding 70% can be preferably used as the active material of a negative electrode depending on the use of the cell. However, in such a case, the energy density of the negative electrode is reduced, which requires the active material layer to be thicker. This may undesirably wrinkle the current collector due to the expansion and contraction at the time of charge/discharge.

When the active material body contains lithium of an amount corresponding to an irreversible capacity, the thickness t of the active material layer is preferably, for example, 1 μm or greater and 100 μm or less, and more preferably 8 μm or greater and 30 μm or less. When the thickness t of the active material layer is 1 μm or greater, a certain level of energy density can be obtained certainly. Therefore, the large capacity characteristic of the active material containing silicon can be fully utilized. When the thickness t of the active material layer is 100 μm or less, the ratio of the area of the active material body to which lithium does not reach as a result of each active material body being shielded by an adjacent active material body, with respect to the entire surface of the active material body, can be suppressed to be low. The collector resistance of each active material body can also be suppressed to be low. These are advantageous for high-rate charge/discharge.

The incidence angle ω of the vapor deposition particles vaporized from the center of the vaporization surface 9S of the vaporization source 9 with respect to the surface of the current collector 4 is preferably 45 degrees or greater and 75 degrees or less. When the incidence angle ω is less than 45 degrees, the active material bodies are curved to protrude in the direction of rising. This provides the problems that it is made difficult to form a vapor deposition film (active material layer) having a space between adjacent active material bodies 110 or 129, and that the current collector 4 is wrinkled due to the expansion and contraction of the active material bodies 110 or 120 at the time of charge/discharge. When the incidence angle ω is 75 degrees or greater, the growth direction of the active material bodies 110 and 120 is significantly inclined with respect to the normal H to the current collector 4, and so the adhering strength of the active material bodies 110 and 120 to the surface of the current collector 4 is decreased. For this reason, the obtained vapor deposition film has a low adherence with the current collector 4, which provides, for example, the problem that the active material is delaminated from the surface of the current collector 4 by charge/discharge.

There is no specific limitation on a width D of the active material bodies 110 and 120. The width D may change in the thickness direction of the active material bodies 110 and 120. In order to prevent the active material bodies 110 and 120 from being ruptured or delaminated from the current collector 4 (for example, copper foil) by the expansion at the time of charge, the width D of the active material bodies 110 and 120 is preferably 100 μm or less, and more preferably 3 to 30 μm. The width D of the active material bodies 110 and 120 can be found as, for example, the width of the active material bodies 110 and 120 at the center of the height thereof provided in any number of 2 to 10 (in the case where the active material bodies 110 and 120 are generally cylindrical, the average value of the diameters of the active material bodies at the center of the height thereof). Herein, the “center of the height” is the center (t/2) of the thickness (height) t of the active material bodies 4 along the normal H to the current collector 4. The “width D” or the “diameter” is, as shown in FIG. 5, the maximum value of the width or the diameter of each active material body 110, 120 in a plane parallel to the surface of the current collector 4.

It is sufficient that the active material bodies 110 and 120 grow to be stacked in a direction away from the current collector 4 from the bumps 4A and 4B of the current collector 4. The shape thereof is not limited to a cylindrical shape or a polygonal column shape.

It is desirable that the measurement of the porosity P of the active material layer, the thickness t of the active material layer, and the width D of the active material bodies 110 and 120 is performed in a state where the active material contains lithium of an amount corresponding to an irreversible amount and does not contain lithium of an amount corresponding to a reversible capacity (in the state where the reversible capacity is 0), namely, in a completely discharged state. The completely discharged state corresponds to a state of a finished cell in which the volume of the active material layer of the negative electrode is minimum.

The porosity P of the active material layer, the thickness t of the active material layer, and the width D of the active material bodies may be measured in a state where the active material does not contain lithium of an amount corresponding to an irreversible capacity. In such a case, by correcting the measured value, the value in the completely discharged state can be obtained. For example, the porosity P of the active material layer which does not contain lithium at all may be measured using a mercury porosimeter. In this case, the value of the porosity P is corrected using a volume difference ΔV between the volume of the active material layer in the completely discharged state containing lithium of an amount corresponding to an irreversible capacity and the volume of the active material layer not containing lithium at all. Porosity P′ of the active material layer containing lithium of an amount corresponding to an irreversible capacity is found by P′=P−ΔV.

There is no specific limitation on the material of the active material bodies 110 and 120, and the active material bodies 110 and 120 may contain at least one active material selected from the group consisting of silicon, tin, silicon oxides, silicon nitrides, tin oxides and tin nitrides. For increasing the capacity of the electrode, it is preferable that the active material bodies 110 and 120 contain a silicon element. More preferably, the active material bodies 110 and 120 are formed of, for example, at least one selected from the group consisting of silicon, silicon alloys, compounds containing silicon and oxygen, and compounds containing silicon and nitrogen. The active material layer may be formed of a single material or a plurality of materials among these. The compounds containing silicon and nitrogen may further contain oxygen. An example of the active material formed of a plurality of materials is formed of a compound containing silicon, oxygen and nitrogen. Another example of such an active material is formed of a composite of a plurality of types of silicon oxides having different ratios of silicon and oxygen. The compound containing silicon and oxygen preferably has a composition represented by general formula: SiOₓ (0<x<2). More preferably, the value of “x” representing the content of the oxygen element is 0.1≦x≦1.2.

The electrode 300 in this embodiment is applicable to various shapes of lithium ion secondary cells such as a cylindrical shape, a flat shape, a coin shape, a polygonal shape and the like. A lithium ion secondary cell may be produced by a known method. Specifically, the electrode 300 is slit to have a prescribed electrode width and wound or stacked as facing a positive electrode plate with a separator being located between the electrode 300 and the positive electrode. As the separator, a polypropylene separator (produced by Celgard; thickness: 20 μm) or the like is usable. The positive electrode plate may be produced as follows. Powder of LiCoO₂, LiNiO₂, LiMn₂O₄ or the like as an active material and acetylene black (AB) are kneaded together with an organic binder such as polyvinylidene difluoride (PVDF) or the like. The resultant substance is applied, dried and rolled on a current collector of, for example, a rolled Al foil having a thickness of 15 μm. Then, the electrolytic solution is injected thereto, and thus a wound cell, a stacked cell or the like is produced.

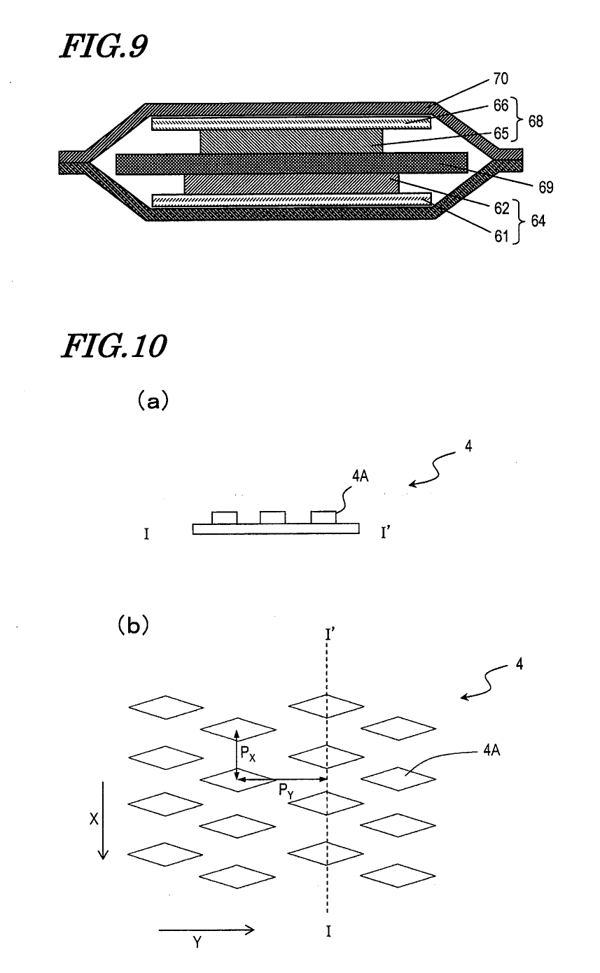

Alternatively, the electrode in this embodiment may be applied to a coin-shaped cell as shown in FIG. 9. A negative electrode 64 of a coin-shaped cell is obtained by forming an active material layer 62 formed of a plurality of active material bodies only on one surface of a current collector 61 using a vapor deposition method in this embodiment. The obtained negative electrode 64 is located to face a positive electrode plate 66 having a positive electrode active material 65 with a separator 69 formed of a microporous film or the like being located between the negative electrode 64 and the positive electrode plate 66, and thus an electrode plate assembly is formed. The electrode plate assembly and an electrolytic solution (not shown) having a lithium ion conductivity are accommodated into a case 70. Thus, the coin-shaped cell can be produced. As the positive electrode active material and the electrolytic solution, materials generally usable for lithium ion secondary cells are usable. For example, as the positive electrode active material, LiCoO₂, LiNiO₂, LiMn₂O₄ or the like is usable. The electrolytic solution may be obtained by dissolving lithium hexafluorophosphate or the like in a cyclic carbonate such as ethylene carbonate, propylene carbonate or the like. There is no specific limitation on the form of sealing the cell.

### Example 1 and Comparative Example 1

Electrodes and electrodes using the same in an example and a comparative example were produced and characteristics thereof were evaluated. This will be described below.

### Example 1

First, an electrode in Example 1 according to the present invention will be described.

1. Production of a Current Collector

A copper alloy foil having a thickness of 18 μm (produced by Hitachi Cable Ltd.; Zr amount: 0.02% by weight) was processed with roller press at a cable pressure of 1 ton/cm using a roller having a generally diamond-shaped bottom surface and a plurality of dents. Thus, a current collector having a plurality of bumps on a surface thereof was formed.

FIGS. 10(a) and 10(b) are respectively a schematic cross-sectional view and a schematic top view of a current collector in Example 1. As shown in the figures, each of bumps 4A was like a rectangular column (average height: 6 μm) having a diamond-shaped top surface (lengths of diagonal: 10 μm×20 μm). A pitch Pₓ of the bumps 4A in an X direction along the shorter diagonal of the diamond shape was 30 μm. Lines of the bumps 4A along the X direction, and another lines of the bumps 4A shifted from the above lines by ½ of the pitch P_{X} in the X direction, were alternately arranged at a pitch P_{y} of 25 μm in a Y direction perpendicular to the X direction.

2. Formation of the Active Material Layer

An active material layer was formed on each of the two surfaces of the current collector using the vapor deposition apparatus shown in FIGS. 6(a) and 6(b) by substantially the same method as described above with reference to FIGS. 1 through 5. With reference to these figures again, a method for forming the active material layer in this example will be described.

In this example, in the chamber 1 of the vapor deposition apparatus 50, the rate of the current collector 4 running between the first roller 3 and the second roller 8 was 11 cm/min. As the vaporization source 9, the carbon crucible 10 located below the vapor deposition zones 35 through 38 and holding silicon having a purity of 99.9999% was used. For vapor deposition, an electron beam set to have an accelerating voltage of −10 kV and an emission current of 450 mA was output from an electron gun 32 to heat the vaporization material.

The nozzles 31a through 31d were connected to a gas pipe (not shown), and the gas pipe was connected to an oxygen tank via a mass flow controller. The nozzles 31a through 31d were located to be directed to the vapor deposition surface of the current collector 4 running in the vapor deposition zones 35 through 38, respectively. From the nozzles 31a through 31d, oxygen gas was supplied to the chamber 1 at a flow rate of 71 sccm. At this point, the inside of the chamber 1 was exhausted by the evacuation pump 2 down to a vacuum degree of 0.034 Pa. In this state, the vapor deposition steps for forming the first layers and the second layers of the active material bodies were performed.

First, as described above with reference to FIGS. 1(a) through 1(e), the first layers 101a and the second layers 102a were deposited on the bumps 4A of the current collector 4 in the vapor deposition zones 35 and 36. The thickness of each of the first layers 101a and the second layers 102a was 0.2 μm or greater and 0.3 μm or less. Next, as described above with reference to FIGS. 2(a) through 2(d), the first layers 101b and the second layers 102b were deposited on the bumps 4B of the current collector 4 in the vapor deposition zones 37 and 38. Then, the current collector 4 was taken in by the second roller 8.

The thickness of each of the first layers 101b and the second layers 102b was 0.2 μm or greater and 0.3 μm or less. The second layers 102a and 102b were grown in a direction inclined, with respect to the normal H to the current collector 4, oppositely to the growth direction of the first layers 101a and 101b. The growth directions (inclination directions) of the first layers 101a and 101b formed on the top and bottom surfaces of the current collector 4 were generally symmetrical to each other with respect to the normal H to the current collector 4. The growth directions (inclination directions) of the second layers 102a and 102b were generally symmetrical to each other with respect to the normal H to the current collector 4. In addition, in this example, the position and the power at which the electron beam was output from the electron gun 32 were adjusted such that the thickness of the first layers 101a and 101b and the thickness of the second layers 102a and 102b would be generally equal to each other.

Next, the flow rate of the oxygen gas was switched to 70 sccm, and the inside of the chamber 1 was exhausted by the evacuation pump 2 down to a vacuum degree of 0.033 Pa. In this state, the vapor deposition steps for forming the third layers and the fourth layers of the active material bodies were performed.

The current collector 4 taken in by the second roller 8 was transported in the opposite direction toward the first roller 3. As described above with reference to FIGS. 3(a) through 3(d), the third layers 103b were deposited on the second layers 102a formed on the bumps 4B of the current collector 4 in the vapor deposition zone 38, and the fourth layers 104b were deposited on the second and third layers 102b and 103b in the vapor deposition zone 37. Next, as described above with reference to FIGS. 4(a) through 4(c) and 5, the third layers 103a were deposited on the second layers 102a formed on the bumps 4A of the current collector 4 in the vapor deposition zone 36, and the fourth layers 104a were deposited on the second and third layers 102a and 103a in the vapor deposition zone 35. Then, the current collector 4 was taken in by the first roller 3.

The inclination directions (growth directions) of the third layers 103b and 103a were the same as the inclination directions (growth directions) of the second layers 102b and 102a, and each second layer and a corresponding third layer formed one pillar-like portion (second portion). The fourth layers 104b grew in a direction inclined, with respect to the normal H to the current collector 4, oppositely to the growth directions of the second and third layers 102b and 103b. The fourth layers 104a grew in a direction inclined, with respect to the normal H to the current collector 4, oppositely to the growth directions of the second and third layers 102a and 103a.

Although the steps after this are not shown, the flow rate of the oxygen gas was switched to 67 sccm, and the inside of the chamber 1 was exhausted by the evacuation pump 2 down to a vacuum degree of 0.032 Pa. In this state, the transportation direction of the current collector 4 was switched. While the current collector 4 was moved in the forward direction (the same direction as the transportation direction in the vapor deposition step for forming the first layers), vapor deposition steps for forming the fifth and sixth layers were performed. The inclination directions (growth directions) of the fifth layers were the same as the inclination directions (growth directions) of the fourth layers, and each fourth layer and a corresponding fifth layer formed one pillar-like portion (third portion). The sixth layers grew in directions inclined, with respect to the normal H to the current collector 4, oppositely to the growth directions of the fourth and fifth layers.

The flow rate of the oxygen gas was switched to 63 sccm, and the inside of the chamber 1 was exhausted by the evacuation pump 2 down to a vacuum degree of 0.030 Pa. In this state, the transportation direction of the current collector 4 was switched. While the current collector 4 was moved in the reverse direction (the opposite direction to the transportation direction in the vapor deposition step for forming the first layers), vapor deposition steps for forming seventh and eighth layers were performed. The inclination directions (growth directions) of the seventh layers were the same as the inclination directions (growth directions) of the sixth layers, and each sixth layer and a corresponding seventh layer formed one pillar-like portion (fourth portion). The eighth layers were grown in directions inclined, with respect to the normal H to the current collector 4, oppositely to the growth directions of the sixth and seventh layers.

After this, vapor deposition steps were performed while switching the transportation direction in a similar manner. The vapor deposition conditions of the steps are shown in Table 1. As shown in Table 1, vapor deposition steps for forming ninth and 10th layers were performed while the current collector 4 was moved in the forward direction with the flow rate of the oxygen gas of 56 sccm and the vacuum degree of the inside of the chamber 1 of 0.028 Pa. Vapor deposition steps for forming 11th and 12th layers were performed while the current collector 4 was moved in the reverse direction with the flow rate of the oxygen gas of 46 sccm and the vacuum degree of the inside of the chamber 1 of 0.022 Pa. Vapor deposition steps for forming 13th and 14th layers were performed while the current collector 4 was moved in the forward direction with the flow rate of the oxygen gas of 33 sccm and the vacuum degree of the inside of the chamber 1 of 0.014 Pa. Vapor deposition steps for forming 15th and 16th layers were performed while the current collector 4 was moved in the reverse direction without introducing the oxygen gas into the chamber 1.

The current collector 4 was transported 27 more times in repetition alternately in the forward and reverse directions without introducing the oxygen gas into the chamber 1 to form 17th through 70th layers. Thus, the active material bodies were obtained. The growth direction of each active material body extends in a zigzag manner in a direction away from the surface of the current collector 4. Each active material body has a structure in which 36 portions, having growth directions inclined in opposite directions alternately with respect to the normal H to the current collector 4, are stacked.

In this manner, the current collector 4 with a plurality of active material bodies formed thereon was obtained. In this example, at one end of the sheet-like current collector 4, the active material bodies were formed only on one surface thereof, and at the other end thereof, the active material bodies were formed only on the opposite surface (bottom surface) thereof. In a central area of the current collector 4 except for the two ends, the active material bodies were formed on both surfaces thereof. The reason for this is, as described below in more detail, vapor deposition performed on the top and bottom surfaces of the sheet-like current collector 4 is started and finished at positions shifted from the ends of the current collector 4.

In the vapor deposition apparatus 50, the vapor deposition zones 35 through 38 are located in a part of the transportation path between the first roller 3 and the second roller 8. Especially, there is a part in which the vapor deposition is not performed between the vapor deposition zone 36 and the vapor deposition zone 37. Therefore, when the current collector 4 starts to be transported from one of the rollers and then is taken in by the other roller, a leading part and a trailing part of the sheet-like current collector 4 do not pass the vapor deposition zones 35/36, or do not pass the vapor deposition zones 37/38. Accordingly, even when the vapor deposition steps are repeated, one end of the current collector 4 never passes the vapor deposition zones 35/36, and the other end of the current collector 4 never passes the vapor deposition zones 37/38. As a result, as described above, the active material bodies are formed only on one surface at the ends of the current collector 4, and on both surfaces in the central area thereof.

After this, a part of the current collector 4 having the active material bodies formed only on one surface (the top or bottom surface) was cut out, and thus a negative electrode 1A was produced.

3. Composition of the Active Material Bodies

The oxygen ratio (the x value in SiOₓ) of the active material bodies (a silicon oxide) in the negative electrode 1A in Example 1 was found by processing the active material bodies by line analysis measurement in a cross-sectional direction thereof using EPMA. Here, the line analysis measurement of the active material bodies was performed on a cross-section perpendicular to the surface of the current collector 4 and including the growth direction of the active material.

The measurement results are shown in Table 1. As shown in Table 1, the x value in the first layers 101a and 101b (first portion) was 1.2. The oxygen ratio (x value) of the active material bodies was continuously decreased from the first layers 101a and 101b (first portion) toward the 15th layers (eighth portion). The x value of the 15th and subsequent layers (eighth and subsequent portions) was 0.2. It was confirmed from the measurement results that the ratio of the oxygen element varies in the thickness direction of the active material layer. This is considered to be caused by the vapor deposition condition (flow rate of the oxygen gas) for forming each layer of the active material bodies.

The oxygen ratio (x value) of the active material layer formed of a plurality of active material bodies was measured by a combustion method. The result was 0.27.

TABLE 1

| | | | Oxygen ratio |
|---|---|---|---|
| Vapor deposition condition | Layer | Stage | (x value) |
| Oxygen gas flow rate: 71 sccm | 1 | 1 | 1.2 |
| Vacuum degree: 0.034 Pa | 2 | 2 | \| |
| Oxygen gas flow rate: 70 sccm | 3 | | \| |
| Vacuum degree: 0.033 Pa | 4 | 3 | \| |
| Oxygen gas flow rate: 67 sccm | 5 | | \| |
| Vacuum degree: 0.032 Pa | 6 | 4 | ↓ |
| Oxygen gas flow rate: 63 sccm | 7 | | Continuously |
| Vacuum degree: 0.030 Pa | 8 | 5 | decreased |
| Oxygen gas flow rate: 56 sccm | 9 | | |
| Vacuum degree: 0.028 Pa | 10 | 6 | |
| Oxygen gas flow rate: 46 sccm | 11 | | |
| Vacuum degree: 0.022 Pa | 12 | 7 | |
| Oxygen gas flow rate: 33 sccm | 13 | | |
| Vacuum degree: 0.014 Pa | 14 | 8 | \| |
| Oxygen gas is not introduced | 15 | | 0.2 |
| Vacuum degree: 0.002 Pa or less | 16 | 9 | |
| Oxygen gas is not introduced | 17 | | |
| Vacuum degree: 0.002 Pa or less | 18-70 | 10-36 | |

4. Observation of the Cross-Section of the Active Material Bodies

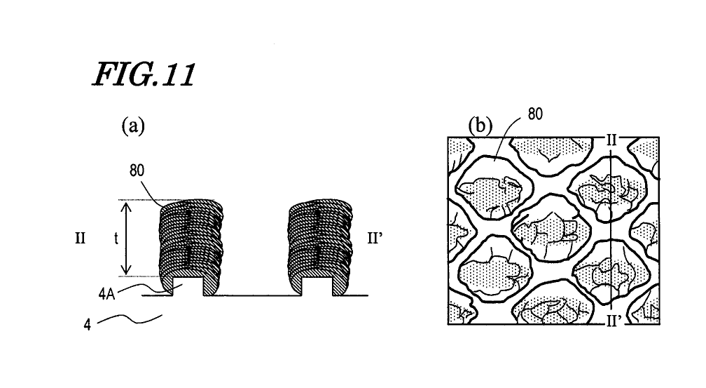

A cross-section of the negative electrode 1A was observed at various angles by a scanning electron microscope (SEM). FIG. 11(a) shows the observed cross-section of the active material bodies of the negative electrode 1A which is perpendicular to the surface of the current collector 4 and includes the growth direction of the active material bodies. FIG. 11(b) is a top view of the active material layer as seen in the normal direction to the current collector 4. FIG. 11(a) is a cross-sectional view taken along line II-II′ of FIG. 11(b).

As a result of the observation, the following was confirmed: each of active material bodies 80 is deposited so as to cover the bump 4A of the current collector 4; and the active material body 80 has a structure in which a portion deposited from the left in the sheet of FIG. 11(a) and a portion deposited from the right in the sheet of FIG. 11(a) are stacked alternately on the bump 4A of the current collector 4. The average thickness t of the active material bodies in the negative electrode 1A was 15 μm.

5. Porosity P of the Active Material Layer

The porosity P of the active material layer in the negative electrode 1A was measured using a mercury porosimeter (Autopore III9410 produced by Shimadzu Corporation).

First, a current collector having active material bodies formed on one surface thereof in substantially the same conditions as above was produced as a porosity measurement sample. The size of the porosity measurement sample was 3 cm×3 cm. The weight of the current collector (copper foil) was subtracted from the weight of the sample to find the weight of the active material layer. Next, the true volume (VT) of the active material layer was found from the density of SiO_{0.27}. Then, mercury was caused to enter the spaces of the sample, and the volume (VH) of the mercury which entered was found by the mercury porosimeter. The porosity P, found from the true volume (VT) of the active material layer and the volume (VH) of the mercury which entered the spaces of the sample, was 50%.

6. Measurement of the Adhering Force of the Active Material Layer

The adhering strength of the active material to the current collector 4 was measured using a tacking tester (TAC-II produced by Rhesca Corporation).

First, a both-sided adhesive tape (No. 515 produced by Nitto Denko Corporation) was attached to a tip of a measuring head (having a tip diameter of 2 mm) of the tacking tester. A piece of 2 cm×3 cm of the negative electrode 1A was cut out to prepare an adhesive strength measurement sample. The both-sided adhesive tape was attached and fixed to a position of the active material layer of this sample which faced the measurement head. The measurement was performed under the conditions of a pressing rate of 30 mm/min., a pressing time of 10 seconds, a load of 400 gf, and a pulling rate of 600 mm/min. As a result, it was confirmed that the adhering strength of the active material was 30 kgf/cm² or greater (the measurement limit or greater because delamination was not confirmed).

7. Production of a Negative Electrode for a Test Cell

The negative electrode 1A was cut into a size of 31 mm×31 mm, and Li metal of 15 μm was vapor-deposited on a surface of the negative electrode by a vacuum vapor deposition method to obtain a negative electrode for a cell. An exposed portion of the current collector (Cu foil) was provided at a position which was on the inner side of the negative electrode for the cell and did not face the positive electrode, and a Cu negative electrode lead was welded thereto.

8. Production of a Positive Electrode for a Test Cell

10 g of lithium cobalt oxide (LiCoO₂) powder having an average particle diameter of 10 μm as a positive electrode active material, 0.3 g of acetylene black as a conductor, 0.8 g of polyvinylidene difluoride (PVDF) powder as a binder, and an appropriate amount of N-methyl-2-pyrrolidone (NMP) solution (#1320 produced by Kureha Corporation) were fully mixed to prepare a positive electrode compound paste. The obtained positive electrode compound paste was applied to one surface of a positive electrode current collector (thickness: 15 μm) formed of a 20 μm-thick aluminum (Al) foil by a doctor blade method. Next, the positive electrode compound paste was rolled so as to have a thickness of 70 μm and fully dried at 85° C. to form a positive electrode active material layer. Then, the positive electrode current collector having the positive electrode active material layer formed thereon was cut into a size of 30 mm×30 mm to obtain a positive electrode for a cell. An exposed portion of the current collector (Al foil) was provided at a position which was on the inner side of the positive electrode for the cell and did not face the negative electrode, and an Al positive electrode lead was welded thereto.

9. Production of a Test Cell

A coin-shaped cell as shown in FIG. 9 was produced using the negative electrode and the positive electrode for the test cell described above to obtain a test cell A.

First, a positive electrode 68 for the test cell and the negative electrode 64 for the test cell were located such that the positive electrode active material layer 65 and the negative electrode active material layer 62 would face each other. The separator 69 formed of a microporous polyethylene layer having a thickness of 20 μm produced by Asahi Kasei Corporation was located between the positive electrode active material layer 65 and the negative electrode active material layer 62. Thus, a thin electrode plate assembly was obtained. This electrode plate assembly was inserted together with an electrolysis into the external case formed of an aluminum laminate seal. Used as the electrolysis was a nonaqueous electrolytic solution obtained by mixing ethylene carbonate (EC) and ethyl methyl carbonate (EMC) at a volume ratio of 1:1 and dissolving LiPF₆ in this mixture at a concentration of 1.0 mol/L. The positive electrode active material layer 65, the negative electrode active material layer 62, and the separator 69 were impregnated with the nonaqueous electrolytic solution. Then, ends of the external case 70 were welded while vacuum pressure reduction was performed in a state where the positive electrode lead and the negative electrode lead (not shown) were drawn out externally. Thus, the test cell A was obtained.

### Comparative Example 1

For comparison, a negative electrode 1B in Comparative Example 1 was produced by forming active material bodies in contact with the bumps of the current collector while moving the current collector in a direction in which the incidence angle ω of the vapor deposition material was increased.

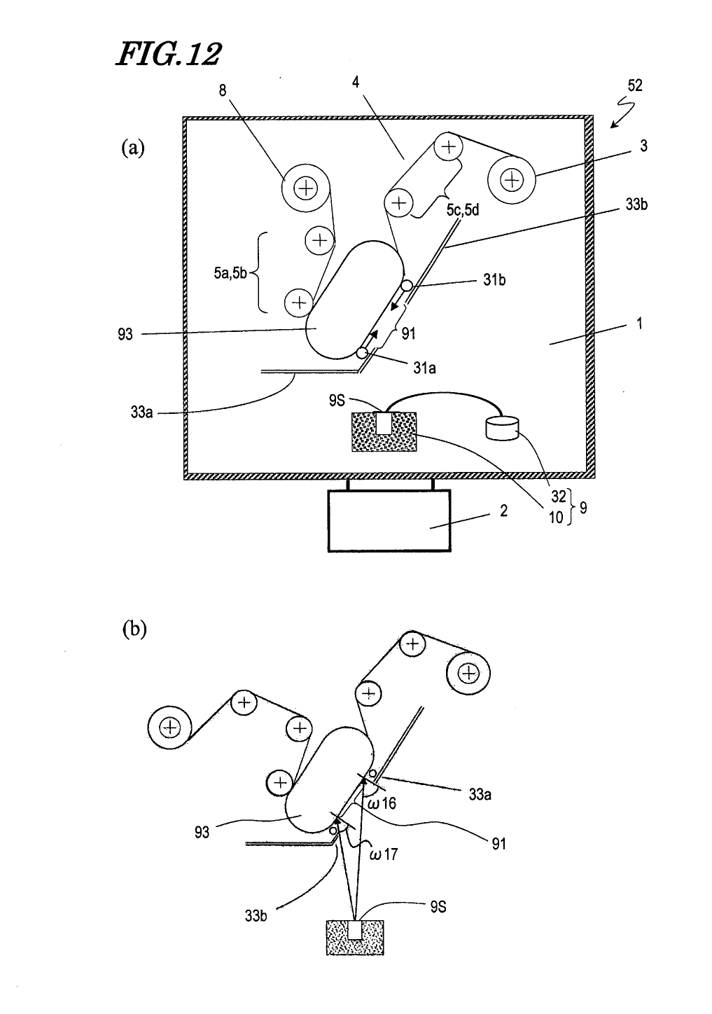

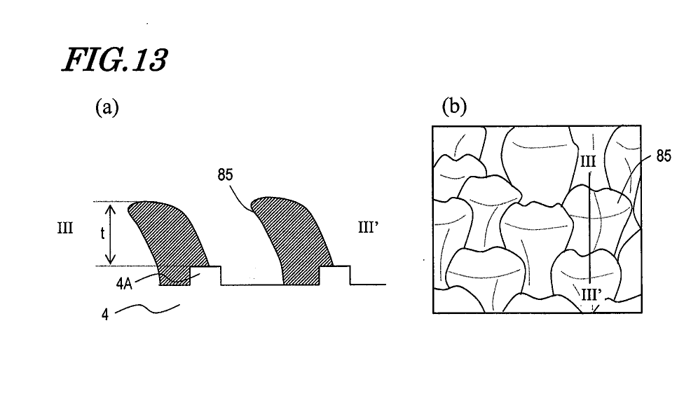

In Comparative Example 1, a current collector substantially the same as that of Example 1 was used. For forming the active material layer, a vapor deposition apparatus 52 as shown in FIG. 12 was used. For the sake of simplicity, elements substantially the same as those of the vapor deposition apparatus 50 shown in FIG. 6 bear identical reference numerals thereto and descriptions thereof will be omitted. In the chamber 1 of the vapor deposition apparatus 52, the current collector 4 was fed out from the second roller 8, caused to pass a vapor deposition zone 91 and transported to the first roller 3 at a rate of 1 cm/min. In the vapor deposition zone 91, vapor deposition was performed while the current collector 4 was moved in a direction away from the vapor deposition surface 9S, namely, in a direction in which the incidence angle ω of the vapor deposition material was increased. The incidence angle ω of silicon was 60 degrees at a bottom end of the vapor deposition zone 91 and 75 degrees at a top end thereof.

As the vaporization source 9, the carbon crucible 10 holding silicon having a purity of 99.9999% was used. An electron beam set to have an accelerating voltage of −10 kV and an emission current of 600 mA was output from the electron gun 32 to heat and vaporize silicon. The nozzle 31a was connected to a gas pipe (not shown), and the gas pipe was connected to an oxygen tank via a mass flow controller. The nozzles 31a and 31b were located respectively at the bottom end and the top end of the vapor deposition zone 91 to be directed to the vapor deposition surface of the current collector 4 running in the vapor deposition zone 91. From the nozzle 31a located at the bottom end of the vapor deposition zone 91, oxygen gas was supplied to the chamber 1 at a flow rate of 40 sccm. From the nozzle 31b located at the top end of the vapor deposition zone 91, oxygen gas was supplied to the chamber 1 at a flow rate of 20 sccm. At this point, the inside of the chamber 1 was exhausted by the evacuation pump 2 down to a vacuum degree of 0.02 Pa.

In the vapor deposition zone 91, silicon vaporized from the vaporization source 9 reacted with the oxygen gas supplied from the nozzle 31a to deposit a compound containing silicon and oxygen (SiOₓ) selectively on the bumps of the current collector 4. At this point, the power of the electron gun 2 was appropriately adjusted such that the thickness of the active material layer formed on the current collector 4 running in the vapor deposition zone 91 would be generally uniform. In this manner, the negative electrode 1B in Comparative Example 1 including an active material layer formed of a plurality of active material bodies was produced.

The oxygen ratio (x value) of the active material layer of the obtained negative electrode 1B was measured by a combustion method. The result was 0.6.

Next, a cross-section of the negative electrode 1B was observed by a scanning electron microscope (SEM). FIG. 13(a) shows the observed cross-section of the active material bodies of the negative electrode 1B which is perpendicular to the surface of the current collector 4 and includes the growth direction of the active material bodies. FIG. 13(b) is a top view of the active material layer as seen in the normal direction to the current collector 4. FIG. 13(a) is a cross-sectional view taken along line III-III′ of FIG. 13(b).

As a result of the observation, the following was confirmed: each of active material bodies 85 has a growth direction inclined in one direction with respect to the normal H to the current collector 4; and each active material body 85 covers the incidence-side side surface of the bump 4A of the current collector 4 (on the silicon incidence side in the vapor deposition step), but does not cover the side surface opposed thereto and so the contact area size between the active material body 85 and the bump 4A of the current collector 4 is smaller than that in Example 1. As understood from FIG. 13(a), each active material body 85 is thick in the vicinity of the current collector 4 and becomes thinner toward a tip thereof. This is considered to occur for the following reason. The incidence angle ω is increased in the vapor deposition step and in accordance with this, the growth direction of the active material body 85 is changed to be more inclined with respect to the normal H to the current collector 4. In Comparative Example 1, the inclination angle (average value) 8 of the active material bodies 85 with respect to the normal H to the current collector 4 was 47 degrees, and the thickness t of the active material bodies 85 along the normal to the current collector 4 was 18 μm.

The porosity P of the negative electrode 1B, which was found using a mercury porosimeter, was 42%.

A tacking test was performed in substantially the same manner as in Example 1. The adhering strength of the negative electrode 1B was 17 kgf/cm², and a part of the negative electrode active material was delaminated from the surface of the current collector 4 by the tacking test.

A coin-shaped cell was produced using the negative electrode 1B in Comparative Example 1 in substantially the same manner as in Example 1 to obtain a test cell B.

### Evaluation on the cells in Example 1 and Comparative Example 1

### (i) Charge/Discharge Characteristic

Evaluation of the charge/discharge characteristic was performed on the test cells A and B in the following manner.

First, the test cells A and B were each accommodated into a thermostat oven of 20° C. and charged by a constant current/constant voltage method. Here, each cell was charged at a constant current of 1 C rate (1 C is a current value at which the entirety of the cell capacity can be used up within 1 hour) until the cell voltage became 4.2 V, and then charged at a constant voltage until the current value became 0.05 C.

After the charge, the operation was paused for 20 minutes. Then, the cell was discharged at a constant current as high as 1 C rate until the cell voltage became 2.5 V. After the high-rate discharge, the cell was re-discharged at a constant current of 0.2 C until the cell voltage became 2.5 V. After the re-discharge, the operation was paused for 20 minutes.

The above-described charge/discharge was repeated by 300 cycles.

In an initial period of the cycles, the ratio of the total discharge capacity (the sum of the high-rate discharge capacity and re-discharge capacity) with respect to the charge capacity was obtained with the percentage as the charge/discharge efficiency. In the initial period of the cycles, the ratio of the high-rate discharge capacity with respect to the total discharge capacity was obtained with the percentage as the high-rate ratio. The ratio of the total discharge capacity at the 300th cycle with respect to the total discharge capacity in the initial period of the cycles was obtained with the percentage as the capacity maintenance ratio.

The measurement results are shown in Table 2.

TABLE 2

| | | | Capacity |
|---|---|---|---|
| | Charge/discharge | High-rate | maintenance |
| | efficiency | ratio | ratio |
| Test cell A | 99.9% | 90% | 80% |
| Test cell B | 99.8% | 91% | 50% |

From Table 2, it was found that the test cells A and B exhibit generally equal and high charge/discharge efficiency and high-rate ratio in the initial period of the cycles. This is considered to occur for the following reasons. One reason is that active material bodies in these test cells each have a part inclined with respect to the current collector and so the area size of a part of the surface of the active material bodies which is in contact with the electrolysis is larger than that in the conventional cells. Another reason is that parts of the negative electrode active material and the positive electrode active material which face each other are increased and so the charge/discharge reaction is made uniform, which suppresses lithium deposition reaction and excessive local charge/discharge of the positive electrode.

However, at the 300th cycle, the capacity maintenance ratio of the test cell A is about 80% whereas the capacity maintenance ratio of the test cell B drops to about 50%. This is considered to occur for the following reasons. One reason is that the active material bodies of the test cell A are structured to have a plurality of stages so as to cover the bumps of the current collector, and so the adhering force between the surface of the current collector and the active material bodies is increased to suppress the delamination, rupture and the like of the active material bodies. Another reason is that in the test cell A, a sufficiently large space is made between adjacent active material bodies, and as a result, the contact between the adjacent active material bodies at the time of charge/discharge is reduced and so the current collector can be suppressed from being wrinkled, distorted or the like.

From the above evaluation results, it was confirmed that by providing the active material bodies which have an underlying layer formed so as to cover the bumps of the current collector and are formed of a plurality of stages, the cycle characteristic of the secondary cell can be improved more effectively.

### Reference Embodiment

Hereinafter, a method for producing an electrode in Reference Embodiment according to the present invention will be described. In this embodiment, active material bodies inclined in one direction with respect to the normal to the current collector are formed unlike in Embodiment 1.

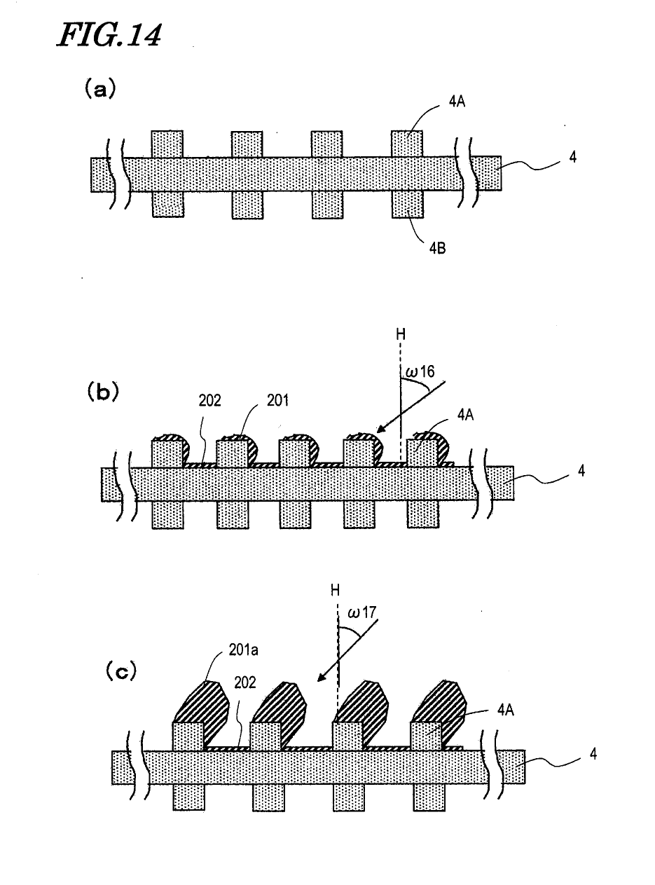

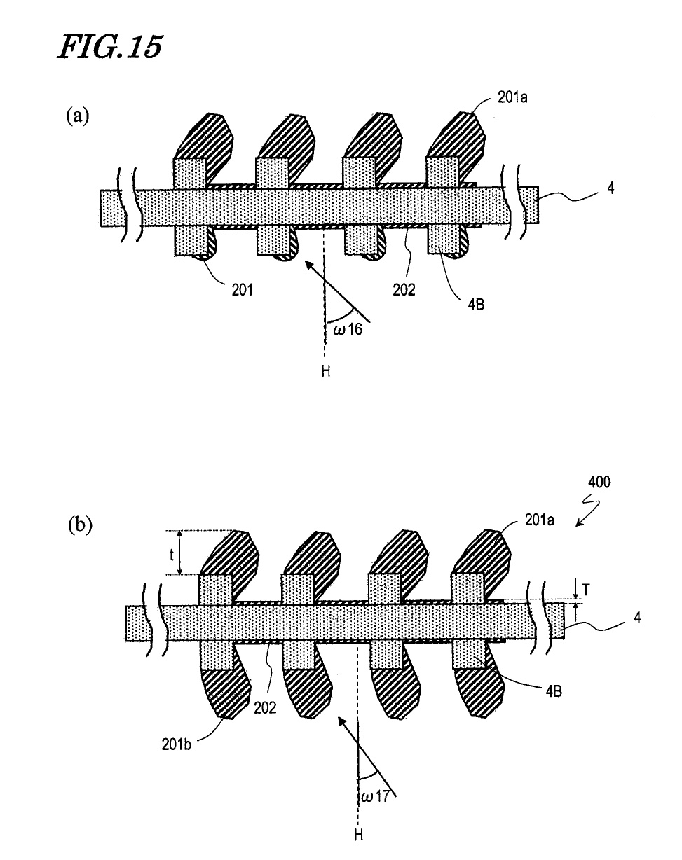

FIGS. 14 and 15 are schematic partial cross-sectional views of steps illustrating a method for producing an electrode in this embodiment.

First, as shown in FIG. 14(a), the current collector 4 having a plurality of bumps 4A and 4B formed on the top and bottom surfaces thereof is produced. Herein, the current collector 4 is a sheet-like foil formed of copper, nickel or the like and having bumps and dents formed on surfaces thereof. The method for forming the current collector 4 may be substantially the same as the method described in Embodiment 1.

Next, the active material bodies are formed on both surfaces of the current collector 4 using the vacuum vapor deposition apparatus 52 shown in FIGS. 12(a) and 12(b). In FIG. 12, elements substantially the same as those of the vapor deposition apparatuses 50 and 51 described above bear identical reference numerals thereto and descriptions thereof will be omitted.

First, the current collector 4 is set to the first roller 3 of the vapor deposition apparatus 52. The vaporization source 10 contains silicon or the like. The vaporization source 10 is heated by a heating device (not shown) such as a resistance heating device, an induction heating device, an electron beam heating device or the like to vaporize silicon. Oxygen gas is introduced into the chamber 1 while the inside of the chamber 1 is exhausted by the evacuation pump 2. In this state, the current collector 4 is fed out from the first roller 3, caused to run on a circumferential surface of a substrate cooling support 6 rotating in a direction of the arrow, and taken in by the second roller 8. On the circumferential surface of the substrate cooling support 6, the vapor deposition zone 91 is provided, and vapor deposition is performed on the current collector 4 in the vapor deposition zone 91.

In the vapor deposition zone 91, while the current collector 4 is moved in a direction approaching the vaporization surface 9S, the vaporized particles are selectively incident on the bumps 4A on the surface of the current collector 4. Specifically, as shown in FIG. 14(b), at the top end of the vapor deposition zone 91, the vaporized particles (silicon) are incident on the surface of the current collector 4 at an angle of w16 (incidence angle) with respect to the normal H to the current collector 4. Silicon reacts with the oxygen gas, and an active material (a silicon oxide) 201 is deposited on the bumps 4A of the current collector 4. At this point, the active material 201 is deposited in a small thickness also between the bumps 4A (dents). As the current collector 4 is moved in the vapor deposition zone 91, the active material bodies 201 grows while the incidence angle ω is decreased from ω16. At the bottom end of the vapor deposition zone 91, the incidence angle ω is ω17. Thus, the active material bodies 201a are formed on the bumps 4A on the surface of the current collector 4 (first layer vapor deposition step). Then, the current collector 4 is taken in by the second roller 8.

Next, the current collector 4 is fed out from the second roller 8, caused to run on the circumferential surface of the substrate cooling support 6 rotating in the direction of the arrow, and taken in by the first roller 3. During this operation, vapor deposition is performed on the current collector 4 in the vapor deposition zone 91.

In the vapor deposition zone 91, while the current collector 4 is moved in a direction approaching the vaporization surface 9S, the vaporized particles are selectively incident on the bumps 4B on the surface of the current collector 4. Specifically, as shown in FIG. 15(a), at the top end of the vapor deposition zone 91, the vaporized particles (silicon) are incident on the surface of the current collector 4 at an angle of w16 (incidence angle) with respect to the normal H to the current collector 4. Silicon reacts with the oxygen gas, and the active material (a silicon oxide) 201 is deposited on the bumps 4B of the current collector 4. At this point, the active material 201 is deposited in a small thickness also between the bumps 4A (dents). As the current collector 4 is moved in the vapor deposition zone 91, the active material bodies 201 grows while the incidence angle ω is decreased from ω16. At the bottom end of the vapor deposition zone 91, the incidence angle ω is ω17. Thus, as shown in FIG. 15(b), the active material bodies 201b are formed on the bumps 4B on the bottom surface of the current collector 4 (first layer vapor deposition step). Then, the current collector 4 is taken in by the second roller 8. In this manner, an electrode 400 in which a plurality of active material bodies 201a and 201b are formed on both surfaces of the current collector 4 is produced.

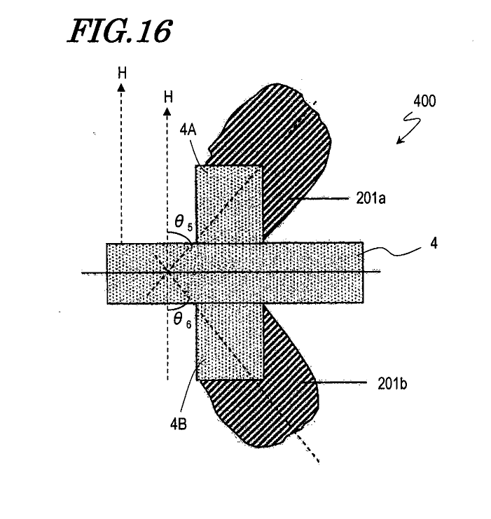

FIG. 16 is a schematic enlarged partial cross-sectional view of the electrode 400. As understood from FIG. 16, the active material bodies 201a and 201b are generally symmetrical to each other with respect to the normal H to the current collector 4. Namely, the active material bodies 201a and 201b are inclined oppositely to each other with respect to the normal H to the current collector 4, and the absolute values of average inclination angles θ₅ and θ₆ are equal to each other.

Hereinafter, with reference to FIG. 14 again, a method for producing the electrode 400 will be described more specifically.

First, as shown in FIG. 14(a), on both surfaces of a copper alloy foil having a thickness of 18 μm, a ruggedness pattern is formed by machining to obtain the current collector 4. The height of the bumps 4A and 4B on the surfaces is, for example, 6 μm. In the shown cross-section, the width of each of the bumps 4A and 4B is 20 μm, and the interval between adjacent bumps is 20 μm.

Next, the current collector 4 is set to the first roller 3 shown in FIG. 12(a). The current collector 4 is fed out from the first roller 3, moved in a direction approaching the vaporization source 9 in the vapor deposition zone 91 on the cooling support 6, and taken in by the second roller 8. In the vapor deposition zone 91, along with the movement of the current collector 4, the incidence angle ω is decreased from ω16 (75° to ω17 (62°). At this point, an active material such as, for example, silicon (scrapped silicon; having a purity of 99.999%) or tin is heated by the heating apparatus 32 such as an electron beam heating device or the like to be vaporized from the vaporization source 9. The inside of the chamber 1 is an oxygen atmosphere having a pressure of 0.02 Pa. Thus, as shown in FIG. 14(b), the vaporized particles are incident on the surface of the current collector 4 at an incidence angle of ω16 (75°). The vaporized particles react with oxygen supplied from the oxygen introduction nozzle 31a in the vicinity of the mask 11a, and thus the active material 101 having a composition of SiOₓ are selectively deposited on the bumps 4A of the current collector 4. At this point, the incidence angle of w16 is sufficiently large to deposit the active material 201 also on the incidence-side side surface of each bump 4A. Therefore, the contact area size between the active material 201 and the current collector 4 can be large. In the shown example, an active material 202 is also deposited in a small thickness on the dents between adjacent bumps 4A. The active material 202 may occasionally not be deposited almost at all depending on the incidence angle ω16, the height of the bumps 4A or the interval between the bumps 4A. Even in such a case, the active material 201 is deposited on at least a part of the incidence-side side surface of the bumps 4A as well as on the top surface thereof. This can improve the adherence between the active material 201 and the current collector 4. Therefore, the active material is suppressed from being delaminated by the expansion and contraction at the time of charge/discharge, and so a high reliability can be obtained.

Then, as shown in FIGS. 14(c) and 12(b), in the vapor deposition zone 91, along with the movement of the current collector 4, the active material 201 grows on the bumps 4A while the incidence angle ω of the vaporized particles is continuously decreased from ω16 (75° to ω17 (62°). Thus, the active material bodies 201a having a composition of SiOₓ are obtained.

The vapor deposition zone 91 in this embodiment includes a plane transportation zone on which the current collector 4 is transported such that the vapor deposition surface of the current collector 4 is planar. Namely, in the shown cross-section, the current collector 4 is transported linearly. With such a structure, as described in Embodiment 1 in detail, the number of vaporized and flying particles and the amount of oxygen supplied from the oxygen introduction nozzles (31a, 31b) continuously change in accordance with the distance from the vaporization surface 9S. Namely, in the vicinity of the bottom end of the vapor deposition zone 91 having a short distance from the vaporization surface 9S, an SiOₓ having a low oxygen ratio x is formed. As the distance from the vaporization surface 9S increases, an SiOₓ having a higher oxygen ratio x is formed. As a result, the oxygen ratio x of the obtained active material bodies 201a is high on the side of the current collector and is gradually decreased along the thickness direction. As the oxygen ratio x is lower, the lithium occluding amount is larger and so the volume expansion ratio by occlusion of lithium is larger. Owing to this, on the current collector side of the active material bodies 201a, the volume expansion can be suppressed to prevent the reduction of the adherence; whereas on the top surface side of the active material bodies 201a, a certain lithium occluding amount can be obtained with certainty. This is advantageous because the charge/discharge capacity is kept large while the active material bodies 201a are suppressed from being delaminated.

The active material bodies 201a in this embodiment are formed on the bumps 40A and are inclined at an angle of θ1 with respect to the normal H to the current collector 4. The thickness t of the active material bodies 201a along the normal H to the current collector 4 (the thickness from the top surface of the bumps 4A) is, for example, 18 μm. Between the bumps 4A (dents) on the surface of the current collector 4, the active material 202 having a thickness T of 0.5 μm along the normal H to the current collector 4 is deposited.

The thickness t of the active material bodies 201a is preferably, for example, 3 μm or greater and 30 μm or less, and more preferably 5 μm or greater and 20 μm or less. When the thickness t of the active material bodies 201a is less than 3 μm, a sufficiently large charge capacity may not be obtained undesirably. The width of the active material bodies 201a increases as the thickness t thereof increases, namely, toward the tip of the active material bodies 201a. Therefore, when the thickness t is excessively large (for example, greater than 30 μm), a sufficiently large space cannot be obtained between the active material bodies 201a, which may undesirably cause the active material to be ruptured or delaminated by the expansion stress at the time of charge. The thickness T of the active material 202 on the dents of the current collector 4 is, for example, 0.1 μm or greater and 2 μm or less. As described above, the active material 202 does not need to be deposited (T=0). The thickness T of the active material 202 is preferably 3 μm or less, and more preferably 1 μm or less. When the thickness T of the active material 202 exceeds 3 μm, the current collector 4 may be wrinkled by the expansion stress at the time of charge, which may deteriorate the cycle characteristic.

Then, the current collector 4 having the active material bodies 201a formed thereon is once taken in by the second roller 8. In the vapor deposition apparatus 52, the current collector 4 is taken in such that the surface of the current collector 4 having the active material bodies 201a formed thereon is external to the bobbin.

Next, the inside of the chamber 1 is once made non-vacuum, and the current collector 4 taken in by the second roller 8 is re-attached to the first roller 3. At this point, the current collector 4 is attached such that the surface opposite to the surface having the active material bodies 201a formed thereon acts as the vapor deposition surface (such that the bottom surface acts as the vapor deposition surface).

Next, the current collector 4 is fed out from the first roller 3 and transported to the second roller 8 via the vapor deposition zone 91. At this point, an active material such as, for example, silicon (scrapped silicon; having a purity of 99.999%) or tin is heated by the heating apparatus 32 such as an electron beam heating device or the like to be vaporized from the vaporization source 9. The inside of the chamber 1 is an oxygen atmosphere having a pressure of 0.02 Pa. Thus, as shown in FIGS. 15(a) and 15(b), the active material bodies 201b are selectively formed on the bumps 4B formed on the bottom surface of the current collector 4 by substantially the same method as for forming the active material bodies 201a described above. The active material 202 is also formed in a small thickness on the dents of the current collector 4. The conditions for forming the active material bodies 201b such as the incidence angle ω, etc., the preferable thickness of the active material bodies 201b and the like are substantially the same as the conditions and the thickness described above regarding the step of forming the active material bodies 201a and will not be repeated here.

In this manner, the electrode 400 in which the plurality of active material bodies 201a and 201b are formed on both surfaces of the current collector 4 is obtained.

With the above-described method, the active material bodies 201a and 201b formed of one layer are formed. Alternatively, the second layer may be formed in the vapor deposition zone 91 by, after the first layer is formed by vapor deposition, causing the current collector 4 once taken in by the second roller 8 to pass the vapor deposition zone 91 again to the first roller 3. Still alternatively, the active material bodies having a desired number of layers may be formed by causing the current collector 4 to run between the first roller 3 and the second roller 8 a desired number of times continuously while the transportation direction is switched. Even in such cases, the second and subsequent layers have a growth direction inclined, with respect to the normal H to the current collector 4, in the same side as the first layer. Therefore, the active material bodies shaped to be inclined in one direction with respect to the normal H to the current collector 4 are obtained.

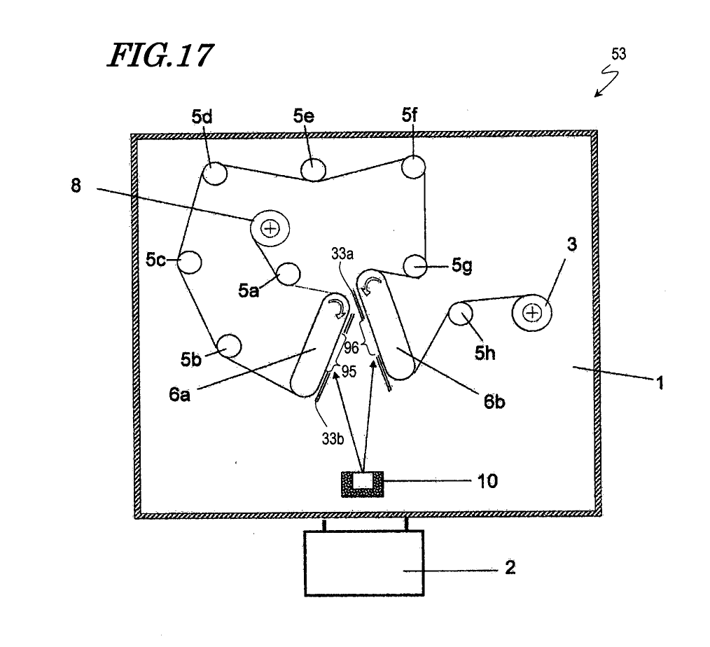

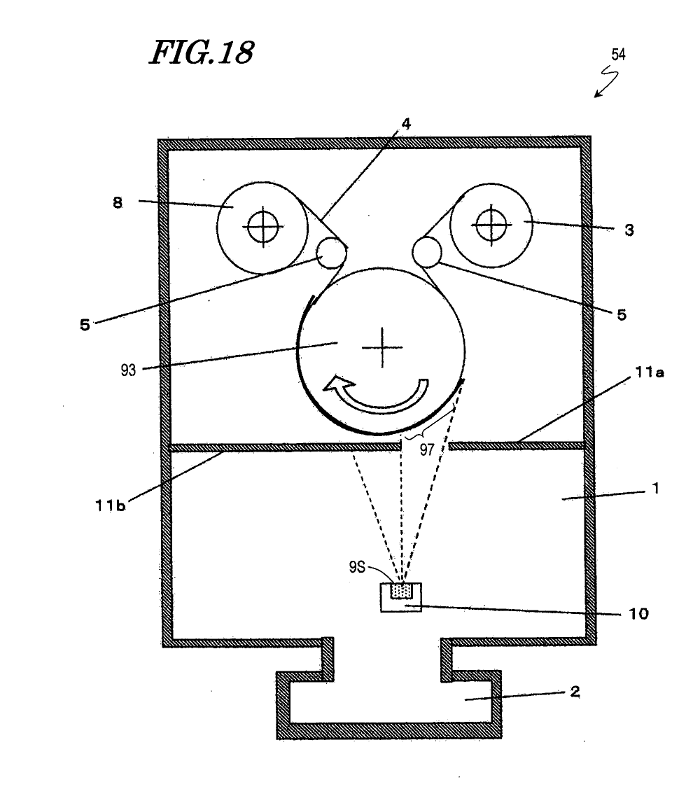

With the above-described method, the vapor deposition apparatus 52 is used. Instead, a vapor deposition apparatus 53 shown in FIG. 17 is usable. In the vapor deposition apparatus 53, the cooling supports 6a and 6b are located to be generally symmetrical to each other with respect to a phantom line passing the center of the vaporization surface 9S and perpendicular to the vaporization surface 9S, and thus form vapor deposition zones 95 and 96. With use of the vapor deposition apparatus 53 having such a structure, the growth direction of the active material bodies 201a on the top surface of the current collector 4 and the growth direction of the active material bodies 201b on the bottom surface of the current collector 4 are generally symmetrical to each other with respect to the normal to the current collector 4. Thus, when the vapor deposition apparatus 53 is used, the active material bodies 201a and 201b can be formed on both surfaces of the current collector continuously with one vaporization source 9 while the inside of the chamber 1 is kept vacuum. This is advantageous because a highly productive step is realized with a simple apparatus structure.

Alternatively, as shown in FIG. 18, a vapor deposition apparatus 54 including a vapor deposition zone 97 formed of a water-cooled can may be used. Owing to this, the current collector 4 can be prevented from being deformed or decreased in strength by a thermal load. Thus, the electrode plate can be suppressed from extending at the time of charge and so a high reliability can be obtained.

In this embodiment, the material, surface roughness Ra and thickness of the current collector 4 and the material of the active material bodies 201a and 201b may be substantially the same as those of Embodiment 1. The preferable range of the porosity P of the active material layers formed of the active material bodies 201a and 201b, and the method for measuring the same, may be substantially the same as those of Embodiment 1.

When the active material contains lithium of an amount corresponding to an irreversible capacity, the thickness t of the active material layers, namely, the thickness of the active material bodies 201a and 201b is preferably, for example, 3 μm or greater and 30 μm or less, and more preferably 5 μm or greater and 20 μm or less. When the thickness t of the active material layer is 3 μm or greater, a sufficient level of energy density can be obtained with certainty. Therefore, the large capacity characteristic of the active material containing silicon can be fully utilized. When the thickness t of the active material layer is 30 μm or less, the ratio of the area of the active material body to which lithium does not reach as a result of each active material body being shielded by an adjacent active material body, with respect to the entire surface of the active material body, can be suppressed to be low. The collector resistance of each active material body can also be suppressed to be low. These are advantageous for high-rate charge/discharge.

In this embodiment, the incidence angle ω in the vapor deposition zone 91 is preferably 45 degrees or greater and 75 degrees or less. When the incidence angle ω is less than 45 degrees, the active material bodies 201a and 201b grow in the direction of rising, which makes it difficult to form a sufficiently large space between the active material bodies 201a and 201b. For this reason, when the cell is charged/discharged, the current collector 4 may be undesirably wrinkled due to the expansion stress of the active material. By contrast, when the incidence angle ω exceeds 75 degrees, the inclination of the incidence angle ω16 with respect to the normal H to the current collector 4 is excessively large and so the active material is not deposited on the side surface of the bumps 4A. This may undesirably reduce the adherence between the current collector and the active material.

The initial incidence angle w16 defined by the mask 33a is preferably 60 degrees or greater and 75 degrees or less, and more preferably 70 degrees or greater and 75 degrees or less. When the initial incidence angle ω16 is less than 60 degrees, the active material 202 deposited between the bumps 4A of the current collector (dents) is excessively thick, and so the current collector 4 may undesirably be wrinkled by the expansion of the active material 202 at the time of charge. On the other hand, the final incidence angle ω17 defined by a mask 33b is preferably 45 degrees or greater. As long as the final incidence angle ω17 is smaller than the initial incidence angle w16, the effect of the present invention is provided. When the difference between these incidence angles (ω16−ω17) is 15 degrees or greater, the adherence between the active material bodies 201a and 201b and the current collector 4 can be improved more certainly.

The preferable range of the width D of the active material bodies 201a and 201b is the same as the range described in Embodiment 1. The definition of the width D and the measuring method thereof are substantially the same as those in Embodiment 1. The shape of the active material bodies 201a and 201b is not limited to a cylindrical shape, or a polygonal column shape.

The thickness t and the width D of the active material bodies 201a and 201b may be measured by substantially the same methods as those described in Embodiment 1.

In this embodiment, the active material bodies 201a and 201b are formed so as to contact the current collector 4. Alternatively, an underlying film may be formed on the current collector 4 before forming the active material bodies 201a and 201b. Still alternatively, the current collector 4 may be surface-treated. The underlying film may contain the same material as that of the active material bodies 201a and 201b. When the active material bodies 201a and 201b contain a silicon oxide (SiOₓ (0<x<2)), the underlying film may contain a silicon oxide having the same composition as, or a different x value from, the active material bodies 201a and 201b. In order to provide the effect of the present invention with a structure having the underlying film, a surface of the underlying film needs to have a shape reflecting the ruggedness pattern of the surface of the current collector 4. Such an underlying film may be formed by, for example, causing vapor deposition particles to be incident perpendicularly to the surface of the current collector 4. The underlying film is, for example, a continuous film.

A lithium ion secondary cell can be produced using the electrode 400 produced as described above, by substantially the same method as described in Embodiment 1. The electrode 400 is applicable to various shapes of lithium ion secondary cells such as a cylindrical shape, a flat shape, a coin shape, a polygonal shape and the like.

### Example 2 and Comparative Example 2

Electrodes and electrodes using the same in an example and a comparative example were produced and characteristics thereof were evaluated. This will be described below.

### Example 2

First, an electrode in Reference Example 2 according to the present invention will be described.

1. Production of a Current Collector

A current collector substantially the same as used in Example 1 was produced by substantially the same method as described above with reference to FIGS. 10(a) and 10(b).

2. Formation of the Active Material Layer

An active material layer was formed on both surfaces of the current collector using the vapor deposition apparatus 52 shown in FIGS. 12(a) and 12(b) by substantially the same method as described above with reference to FIGS. 14 and 15. With reference to these figures again, a method for forming the active material layer in this example will be described.

In this example, in the chamber 1 of the vapor deposition apparatus 52, the rate of the current collector 4 running between the first roller 3 and the second roller 8 was 1 cm/min. As the vaporization source 9, the carbon crucible 10 located below the vapor deposition zone 91 and holding silicon having a purity of 99.9999% was used. For vapor deposition, an electron beam set to have an accelerating voltage of −10 kV and an emission current of 600 mA was output from the electron gun 32 to heat the vaporization material.

The nozzles 31a and 31b were connected to a gas pipe (not shown), and the gas pipe was connected to an oxygen tank via a mass flow controller. Oxygen gas was supplied from the nozzle 31a located at the top end (on the side on which the incidence angle w was larger) of the vapor deposition zone 91 at a flow rate of 40 sccm, and from the nozzle 31b located at the bottom end (on the side on which the incidence angle ω was smaller) of the vapor deposition zone 91 at a flow rate of 20 sccm. At this point, the inside of the chamber 1 was exhausted by the evacuation pump 2 down to a vacuum degree of 0.02 Pa. In this state, the vapor deposition steps for forming the active material bodies 201a were performed.

First, as described above with reference to FIGS. 14(b) and 14(c), the active material bodies 201a (thickness: 18 μm) formed of a compound containing silicon and oxygen (SiOₓ) was formed on the bumps 4A of the current collector 4 in the vapor deposition zone 91 by the vapor from the vaporization source 9. The active material bodies 201a grew in a direction inclined with respect to the normal H to the current collector 4. The position and the power at which the electron beam was output from the electron gun 32 were adjusted such that the thickness t of the active material layer formed of the active material bodies 201a would be uniform. Then, the current collector 4 having the active material bodies 201a formed thereon was taken in by the second roller 8.

Next, the inside of the chamber 1 was once made non-vacuum, and the current collector 4 taken in by the second roller 8 was re-attached to the first roller 3. At this point, the current collector 4 was attached such that the surface opposite to the surface having the active material bodies 201a formed thereon would act as the vapor deposition surface (such that the bottom surface would act as the vapor deposition surface).

Then, the active material bodies b were formed on the bottom surface of the current collector 4 in substantially the same conditions as for forming the active material bodies 201a. Specifically, oxygen gas was introduced into the chamber 1 from the oxygen nozzle 31a at a flow rate of 40 sccm and from the oxygen nozzle 31b at a flow rate of 20 sccm, and the inside of the chamber 1 was exhausted by the evacuation pump 2 down to a vacuum degree of 0.02 Pa.

Next, as described above with reference to FIGS. 15(a) and 15(b), the active material bodies 201b (thickness: 18 μm) formed of a compound containing silicon and oxygen (SiOₓ) was formed on the bumps 4B of the current collector 4 in the vapor deposition zone 91 by the vapor from the vaporization source 9. The active material bodies 201b grew in a direction inclined with respect to the normal H to the current collector 4. The position and the power at which the electron beam was output from the electron gun 32 were adjusted such that the thickness t of the active material layer formed of the active material bodies 201b would be uniform. Then, the current collector 4 having the active material bodies 201a formed thereon was taken in by the second roller 8. Thus, an electrode 2C in Reference Example was obtained.

In the electrode 2C in Reference Example, the growth directions of the active material bodies 201a and 201b were generally symmetrical to each other with respect to the normal H to the current collector 4.

3. Composition of the Active Material Bodies

The oxygen ratio (the x value in SiOₓ) of the active material bodies (a silicon oxide) 201a and 201b in the negative electrode 2C in Reference Example 2 was found by processing the active material bodies by line analysis measurement in a cross-sectional direction using EPMA. Here, the line analysis measurement of the active material bodies was performed on a cross-section perpendicular to the surface of the current collector 4 and including the growth direction of the active material.

As a result, the x value in the vicinity of the interface between the active material bodies 201a and 201b and the current collector 4 was 0.8. The oxygen ratio (x value) of the active material bodies 201a and 201b was decreased in a direction away from the current collector 4, and the x value on the top surface of the active material bodies 201a and 201b was 0.4. It was confirmed that the ratio of the oxygen element varies in the thickness direction of the active material bodies 201a and 201b.

The oxygen ratio (x value) of the active material layer formed of a plurality of active material bodies was measured by a combustion method. The result was 0.6.

4. Observation of the Cross-Section of the Active Material Bodies

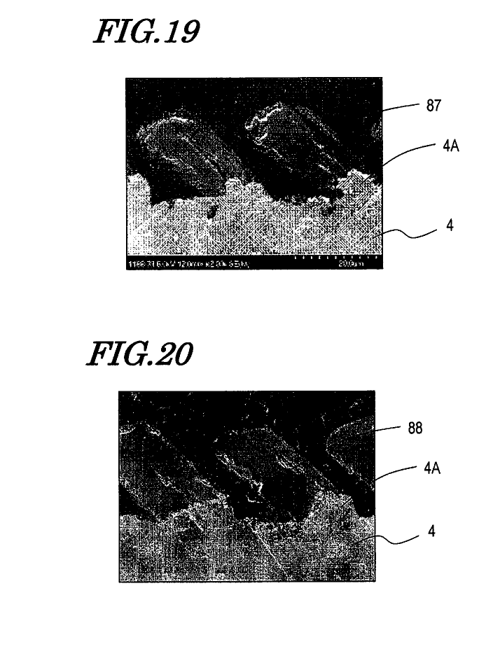

Next, a cross-section of the negative electrode 2C was observed at various angles by a scanning electron microscope (SEM). FIG. 19 shows the observed cross-section of the active material bodies of the negative electrode 2C which is perpendicular to the surface of the current collector 4 and includes the growth direction of the active material bodies.

As a result of the observation, it was confirmed that each of active material bodies 87 was selectively deposited on the bump 4A of the current collector 4. The thickness t of the active material bodies 87 was 18 μm. On the dents of the current collector 4, the active material was deposited in a small thickness, and the thickness T thereof was 0.5 μm. It was found that the width of the active material bodies 87 was large on the side of the current collector and small at the tip thereof. The inclination angle of the active material bodies 87 with respect to the normal H to the current collector 4 was 47 degrees.

5. Porosity P of the Active Material Layer

The porosity P of the active material layer in the negative electrode 2C was measured using a mercury porosimeter (Autopore III9410 produced by Shimadzu Corporation).

First, a current collector having an active material layer formed on one surface thereof in substantially the same conditions as above was produced as a porosity measurement sample. The size of the porosity measurement sample was 3 cm×3 cm. The weight of the current collector (copper foil) was subtracted from the weight of the sample to find the weight of the active material layer. Next, the true volume (VT) of the active material layer was found from the density of SiO_{0.27}. Then, mercury was caused to enter the spaces of the sample, and the volume (VH) of the mercury which entered was found by the mercury porosimeter. The porosity P, found from the true volume (VT) of the active material layer and the volume (VH) of the mercury which entered the spaces of the sample, was 48%.

6. Production of a Test Cell

Using the negative electrode 2C, a negative electrode for a test cell was produced by substantially the same method as described in Example 1. A positive electrode for a test cell was produced by substantially the same method as described in Example 1. Using these, a coin-shaped cell was obtained as a test cell C.

### Comparative Example 2

For comparison, an electrode 2D in Comparative Example 2 was produced by forming active material bodies so as to be in contact with the bumps of the current collector while moving the current collector in a direction in which the incidence angle ω of the vapor deposition material was increased. A method for producing this will be described.

In Comparative Example 2, a current collector substantially the same as that in Reference Example 2 and the vapor deposition apparatus 52 were used. In the chamber 1 of the vapor deposition apparatus 52, the current collector 4 was fed out from the second roller 8, caused to pass the vapor deposition zone 91 and transported to the first roller 3 at a rate of 1 cm/min. In the vapor deposition zone 91, vapor deposition was performed while the current collector 4 was moved in a direction away from the vapor deposition surface 9S, namely, in a direction in which the incidence angle ω of the vapor deposition material was increased. The incidence angle ω of silicon was 62 degrees at the bottom end of the vapor deposition zone 91 and 75 degrees at the top end thereof.

As the vaporization source 9, the carbon crucible 10 holding silicon having a purity of 99.9999% was used. An electron beam set to have an accelerating voltage of −10 kV and an emission current of 600 mA was output from the electron gun 32 to heat and vaporize silicon. The nozzles 31a and 31b were connected to a gas pipe (not shown), and the gas pipe was connected to an oxygen tank via a mass flow controller. From the nozzle 31b located at the bottom end of the vapor deposition zone 91, oxygen gas was supplied to the chamber 1 at a flow rate of 20 sccm. From the nozzle 31a located at the top end of the vapor deposition zone 91, oxygen gas was supplied to the chamber 1 at a flow rate of 4 40 sccm. At this point, the inside of the chamber 1 was exhausted by the evacuation pump 2 down to a vacuum degree of 0.02 Pa.

In the vapor deposition zone 91, silicon vaporized from the vaporization source 9 reacted with the oxygen gas supplied from the nozzles 31a and 31b to deposit a compound containing silicon and oxygen (SiOₓ) selectively on the bumps of the current collector 4. Thus, the active material bodies were formed. At this point, the power of the electron gun 2 was appropriately adjusted such that the thickness of the active material layer formed on the current collector 4 running in the vapor deposition zone 91 would be generally uniform.

Next, the inside of the chamber 1 is once made non-vacuum, and the current collector 4 taken in by the second roller 8 was re-attached to the first roller 3 such that the bottom surface of the current collector 4 would act as the vapor deposition surface. Then, the active material bodies were formed also on the bottom surface of the current collector 4 in the vapor deposition zone 91 by substantially the same method as described above. Thus, the negative electrode 2D in Comparative Example 2 was obtained. The growth directions of the active material bodies formed on the top and bottom surfaces of the current collector 4 were generally symmetrical to each other with respect to the normal H to the current collector 4.

The oxygen ratio (the x value in SiOₓ) of the active material bodies (a silicon oxide) in the obtained negative electrode 2D was found by processing the active material bodies by line analysis measurement in a cross-sectional direction using EPMA. As a result, the x value in the vicinity of the interface between the active material bodies and the current collector 4 was 0.4. The x value was decreased in a direction away from the current collector 4, and was 0.8 on the top surface (head) thereof.

Next, the cross-section of the negative electrode 2D was observed by a scanning electron microscope (SEM). FIG. 20 shows the observed cross-section of the active material bodies of the negative electrode 2D which is perpendicular to the surface of the current collector 4 and includes the growth direction of the active material bodies.

As a result of the observation, it was confirmed that active material bodies 88 were formed on the dents as well as on the bumps 4A of the current collector 4. The thickness t of the active material bodies 88 was 18 μm. On a part of the dents of the current collector 4 on which the active material bodies 88 were not formed, the active material layer was deposited in a small thickness, and the thickness T thereof was 3 μm.

The width of each active material body 88 was large on the side of the current collector and was decreased toward the tip thereof. The inclination angle of the active material bodies 88 with respect to the normal H to the current collector 4 was 42 degrees.

From the observation results of the negative electrodes 2C and 2D in Reference Example 2 and Comparative Example 2, it was confirmed that when vapor deposition is performed while the current collector is moved in a direction in which the incidence angle ω is decreased (Reference Example 2), the amount of the active material deposited on the dents of the current collector 4 can be decreased than when vapor deposition is performed while the current collector is moved in a direction in which the incidence angle ω is increased (Comparative Example 2). It was also found that in Reference Example 2, the active material bodies can be formed selectively on the bumps more certainly and a sufficiently large space can be secured between the active material bodies. It was further found that in Reference Example 2, the active material bodies which are thin on the side of the current collector and thick at the tip thereof are formed and so the current collector can be suppressed more effectively from being deformed due to the expansion stress of the active material.

The porosity P of the negative electrode 2D, which was found using a mercury porosimeter, was 46%.

A coin-shaped cell was produced using the negative electrode 2D in Comparative Reference Example 2 in substantially the same manner as in Example 2 as a test cell D.

### Evaluation on the cells in Reference Example 2 and Comparative Example 2

### (i) Charge/Discharge Characteristic

Evaluation of the charge/discharge characteristic was performed on the test cells C and D in the following manner.

First, the test cells C and D were each accommodated into a thermostat oven of 20° C. and charged by a constant current/constant voltage method. Here, each cell was charged at a constant current of 1 C rate (10 is a current value at which the entirety of the cell capacity can be used up within 1 hour) until the cell voltage became 4.2 V, and then charged at a constant voltage until the current value became 0.05 C.

After the charge, the operation was paused for 20 minutes. Then, the cell was discharged at a constant current as high as 1 C rate until the cell voltage became 2.5 V. After the high-rate discharge, the cell was re-discharged at a constant current of 0.2 C until the cell voltage became 2.5 V. After the re-discharge, the operation was paused for 20 minutes.

The above charge/discharge was repeated by 200 cycles.

In an initial period of the cycles, the ratio of the total discharge capacity (the sum of the high-rate discharge capacity and re-discharge capacity) with respect to the charge capacity was obtained with the percentage as the charge/discharge efficiency. In the initial period of the cycles, the ratio of the high-rate discharge capacity with respect to the total discharge capacity was obtained with the percentage as the high-rate ratio. The ratio of the total discharge capacity at the 200th cycle with respect to the total discharge capacity in the initial period of the cycles was obtained with the percentage as the capacity maintenance ratio.

The measurement results are shown in Table 3.

TABLE 3

| | Charge/ | | Capacity | |
|---|---|---|---|---|
| | discharge | High-rate | maintenance | Electrode |
| | efficiency | ratio | ratio | plate shape |
| Test cell C | 99.9% | 90% | 85% | Not wrinkled |
| Test cell D | 99.8% | 91% | 73% | Wrinkled |

From Table 3, it was found that the test cells C and D exhibit generally equal and high charge/discharge efficiency and high-rate ratio in the initial period of the cycles. This is considered to occur for the following reasons. One reason is that active material bodies in these test cells have a part inclined with respect to the current collector and so the area size of a part of the surface of the active material bodies which is in contact with the electrolysis is larger than that in the conventional cells. Another reason is that parts of the negative electrode active material and the positive electrode active material which face each other are increased and so the charge/discharge reaction is made uniform, which suppresses lithium deposition reaction and excessive local charge/discharge of the positive electrode.

However, at the 200th cycle, the capacity maintenance ratio of the test cell C is about 85% whereas the capacity maintenance ratio of the test cell D drops to about 73%. This is considered to occur for the following reason.

The active material bodies of the test cell C are formed while the current collector is moved in a direction in which the incidence angle ω is decreased, and so the active material bodies can be selectively located on the bumps. Therefore, the amount of the active material deposited on the dents of the current collector can be decreased, and a sufficiently large space can be obtained with certainty between the active material bodies. As a result, the stress applied on the current collector at the time of charge/discharge by the expansion and contraction of the active material on the dents of the current collector and the contact between the active material bodies can be decreased. For this reason, the current collector can be suppressed from being wrinkled or distorted, and the active material bodies can be suppressed from being delaminated or ruptured.

From the above evaluation results, it was confirmed that by forming the active material bodies selectively on the bumps of the current collector and decreasing the amount of the active material deposited on the dents of the current collector, the charge/discharge cycle characteristic can be improved.

### INDUSTRIAL APPLICABILITY

The present invention is applicable to the production of cells for various forms of electrochemical devices. The present invention is especially advantageous when being applied to the production of a lithium secondary cell required to have a large capacity and a good cycle characteristic. There is no specific limitation on the shape of the lithium secondary cell to which the present invention is applicable, and the lithium secondary cell may have any of various shapes including a coin shape, a button shape, a sheet shape, a cylindrical shape, a flat shape, a polygonal shape and the like. The electrode plate assembly including the positive electrode, the negative electrode and the separator may of either a wound type or a stacked type. The cell may be small and used for compact mobile devices or the like, or large and used for electric vehicles or the like. A lithium ion secondary cell produced by a production method according to the present invention is usable as a power supply of, for example, mobile information terminals, mobile electronic devices, home-use compact power storage devices, motorcycles, electric vehicles, hybrid electric vehicles and the like, but the use of the cell is not specifically limited.

1. A method for producing an electrode for an electrochemical device, comprising the steps of:
preparing a sheet-like current collector having a plurality of bumps on a surface thereof, the plurality of bumps having a height of 3 μm or greater and 10 μm or less; and
forming an active material body having a stacked structure on each of the bumps of the current collector;
wherein the step of forming the active material body includes:
a first layer vapor deposition step of causing a vaporized vapor deposition material to be incident on the surface of the current collector in a direction inclined with respect to the normal to the current collector to form a first layer of the active material body on each bump, the first layer being located closest to the current collector; and
a second layer vapor deposition step of causing the vaporized vapor deposition material to be incident on the surface of the current collector in a direction inclined, with respect to the normal to the current collector, opposite to the incidence direction of the vapor deposition material in the first layer vapor deposition step to form a second layer on at least a part of the first layer;
wherein:
in the first layer vapor deposition step, vapor deposition is performed while moving the current collector in a direction in which the incidence angle of the vapor deposition material with respect to the normal to the current collector is decreased; and
the first layer vapor deposition step is followed by the second layer vapor deposition step without causing the vapor deposition material to be incident on the surface of the current collector in a direction of the normal to the current collector.

2. The method for producing an electrode for an electrochemical device of claim 1, wherein in the second layer vapor deposition step, vapor deposition is performed while moving the current collector in a direction in which the incidence angle of the vapor deposition material with respect to the normal to the current collector is increased.

3. The method for producing an electrode for an electrochemical device of claim 2, wherein the first layer of the active material body is formed so as to be in contact with a part of the surface of each bump, and the second layer is formed so as to be in contact with a part of the surface of each bump which is not in contact with the first layer.

4. A method for producing an electrode for an electrochemical device comprising the steps of preparing a sheet-like current collector having a plurality of bumps on a surface thereof, and forming an active material body having a stacked structure on each of the bumps of the current collector; wherein:
the step of forming the active material body is performed using a vapor deposition apparatus which includes a chamber, a vaporization source located in the chamber for vaporizing a vapor deposition material, and a mask for shielding the current collector to prevent the vapor deposition material from being incident on the current collector, and also has a first vapor deposition zone and a second vapor deposition zone in the chamber, the first vapor deposition zone and the second vapor deposition zone being located so as not to overlap each other with respect to the vaporization source, a shielding zone being formed, between the first vapor deposition zone and the second vapor deposition zone, to which the vapor deposition material from the vaporization source does not reach;
the step of forming the active material body includes a forward direction transportation step (A) of performing vapor deposition while moving the current collector in the first vapor deposition zone and the second vapor deposition zone in this order, and a reverse direction transportation step (B), performed after the step (A), of performing vapor deposition while moving the current collector in an opposite direction to the transportation direction of the current collector in the step (A) in the second vapor deposition zone and the first vapor deposition zone in this order, each of the forward direction transportation step (A) and the reverse direction transportation step (B) being performed at least once; and
the forward direction transportation step (A) performed for the first time includes:
(a1) a first layer vapor deposition step of causing the vapor deposition material to be incident on the surface of the current collector in a first direction inclined with respect to the normal to the current collector while decreasing the incidence angle of the vapor deposition material with respect to the normal to the current collector in the first vapor deposition zone to form a first layer on each bump of the current collector, the first layer being located closest to the current collector;
(a2) a second layer vapor deposition step of causing the vapor deposition material to be incident on the surface of the current collector in a second direction inclined, with respect to the normal to the current collector, oppositely to the first direction while increasing the incidence angle of the vapor deposition material with respect to the normal to the current collector in the second vapor deposition zone to form a second layer on at least a part of the first layer; and
another step, performed between the steps (a1) and (a2), of moving the current collector which has passed the first vapor deposition zone to the second vapor deposition zone through the shielding zone, thereby moving the current collector which has passed the first vapor deposition zone to the second vapor deposition zone without the vapor deposition material being incident on the surface of the current collector in a direction of the normal to the current collector.

5. The method for producing an electrode for an electrochemical device of claim 4, wherein:
the reverse direction transportation step performed for the first time includes:
(b1) a third layer vapor deposition step of causing the vapor deposition material to be incident on the surface of the current collector in the second direction with respect to the normal to the current collector while decreasing the incidence angle of the vapor deposition material with respect to the normal to the current collector in the second vapor deposition zone to form a third layer; and
(b2) a fourth layer vapor deposition step of causing the vapor deposition material to be incident on the surface of the current collector in the first direction with respect to the normal to the current collector while increasing the incidence angle of the vapor deposition material with respect to the normal to the current collector in the first vapor deposition zone to form a fourth layer.

6. The method for producing an electrode for an electrochemical device of claim 4, wherein the first and second vapor deposition zones each include a planar transportation zone in which the current collector is transported such that the surface of the current collector is planar.

7. The method for producing an electrode for an electrochemical device of claim 4, wherein the forward transportation step and the reverse transportation step are alternately repeated a plurality of times.

8. The method for producing an electrode for an electrochemical device of claim 2, wherein the incidence angle of the vapor deposition material in the first vapor deposition step and the second vapor deposition step is changed in a range between 45 degrees and 75 degrees.

9. The method for producing an electrode for an electrochemical device of claim 1, wherein the step of preparing the current collector includes the step of forming a plurality of bumps on a metal foil having a surface roughness Ra of 0.3 μm or greater and 5.0 μm or less, and the plurality of bumps are regularly arranged on the surface of the current collector.

10. The method for producing an electrode for an electrochemical device of claim 1, wherein the active material body contains at least one active material selected from the group consisting of silicon, tin, silicon oxides, silicon nitrides, tin oxides and tin nitrides.

11. The method for producing an electrode for an electrochemical device of claim 2, wherein a total thickness of the first layer and the second layer is 0.1 μm or greater and 3 μm or less.

12. An electrochemical device produced by the method of claim 1.
